(19) United States
(12) Patent Application Publication
(10) Pub. No.: US 2007/0255694 A1
(43) Pub. Date: Nov. 1, 2007

(54) Document-drafting system using document components

(76) Inventor: Jianqing Wu, Beltsville, MD (US)

Correspondence Address: AZ PATENT LAW FIRM, P.O. Box 1921, Beltsville, MD, 20704, US

(21) Appl. No.: 11/697,826

(22) Filed: Apr. 9, 2007

Related U.S. Application Data
(60) Provisional application No. 60/744,409, filed on Apr. 7, 2006.

(51) Int. Cl. G06F 17/30; G06F 7/00; G06F 17/00; G06F 3/048

(52) U.S. Cl. 707/3; 707/100; 715/500; 715/530; 715/540; 715/781; 715/764

(57) ABSTRACT

A document-drafting system, including both desktop system and server-client system, uses one or more database tables which contains plural document-building blocks or document components. Through a user interface, a user can search for a document using plural search methods from the database, retrieve a set of document components as a complete document, delete any building block, select a building block from plural mutually exclusive building blocks, completely rewrite any block, search for a building block from a master database and add it to the existing building blocks, customize values for a list of words and phrases in the document. The system returns a presentable document after the user finally submits the edited document building blocks. The system also allows the user to combine plural documents and create cross-references between two documents.

### CROSS-REFERENCE TO RELATED APPLICATION

This patent application claims the priority from the Provisional Patent Application Ser. 60/744,409, filed Apr. 7, 2006, the contents of which are incorporated herein by reference in the entirety.

### FIELD OF THE INVENTION

This invention relates to computer software technology, and particularly to document-drafting system.

### BACKGROUND OF THE INVENTION

Drafting documents such as lease, agreement, and business letters is time-consuming human activity. Computer word processors have changed document-drafting art profoundly over the years. Word processors for computers provide tools in editing, formatting documents, and a number of utilities. Most of the computer processors may also provide document templates, which are to be customized by users. Some templates may contains some basic entries or customize some entries. Some templates may allow a user to fill words and phrases into the templates. In another form, a user is prompted to answer a few questions concerning the matter with which the document is concerned. The computer then fills the answers in the right places in the document.

When a user customizes a document, the user is prompted a series of questions and the user answers them. The user may not be able to see the document template and does not know how his answers might affect the document. If the user cannot answer a question or does not have an answer to the question, the user is not in a position to propose an alternative answer. The user may spend a great deal of time in filling out the answers, but is unable to successfully customize the document because his answer is incomplete. In using this method, the user will have little control over the document after the user has chosen a template. If the user is not satisfied with the document, the user will have to repeat the entire process again using another template. In some cases, the user cannot modify and change any part of the document until the document is created. If for any reason, the user must make a major change that increases or decreases the number of paragraphs, the user may have to renumber the paragraphs and update internal references for the document. By using this method, the user is not provided with help specifically related to each part of the document. Also, if the user wants to add certain materials that are not common, the user has to edit the document after the document is created. This will require a lot of time and effort.

The current document drafting systems may be properly referred to as closed drafting systems. Although many variations are available can be provided to users for customization, a typical drafting system can never provide enough choices for any person. It is often the case that a word processor provides too many unwanted templates and never provides enough what a particular user wants. In any closing system, it is highly unlikely that loaded templates can meet the need of all users.

Therefore, there is a need for a document-drafting system that allows the user to choose substance before the document is processed. There is a need for a method that allows users to add and remove any part of document language. It is desirable that help instruction is provided for each of the topic or subject in the document. There is also a need for a method allowing creation of a combination of documents. It is desirable that the user can have flexibility to write-in words and phrases. There is also a need for a large number of choices.

### SUMMARY OF THE INVENTION

The present invention is a method of and system for drafting documents using a database containing document components. It includes both desktop computer implementation and Internet implementation.

Document components are building blocks, which are referred to by subtitles and can be labeled with a series of numbered labels such as “Section 1” for reference. A document component in this disclosure is similar to clause in legal instrument but its scope is broader. It may include title name, comment, note and the like which is not used in the final document.

Each of the document components in the database has a unique ID for identification purpose, and has one or more position values defining its position relative to other document components. The system and method allows a user to retrieve a set of document components on the basis of type, subtype, species, and other properties such as the desirable number of subject-equivalent but varying components, degree of formality, level of details, and tone and voice. Subject-equivalents components address the same subject but vary in wording, length, detail level, tone and voice, and relative protection level for the parties.

The system retrieves a substantially complete set of document components from the database, extracts the text variables (the text which may vary in a specific document and they are different from program variables) from the components, and save them in a set of variables. It then presents the text of the component together with help text, and the text variables to the user on a drafting workspace or page on a user interface. For each of the components, the drafting workspace has three areas: the display area for the help text, the display area for the component text, and input area for inputting values for the text variables. When a document database has plural subject-equivalent components, subject-equivalent components may be retrieved and displayed on the drafting workspace on the user interface so the user can choose one of them. Each of the subject-equivalent components preferably has its own help text and its own text variables in the input area.

The user can read each document component, relevant help text, and type in necessary information for each of the text variables in the input area. For subject-equivalent components, the user can choose one of the equivalents by pressing one of a set of mutually exclusive buttons on the screen.

For any of the components that significantly affect the rights and obligations of the parties and the look and feel of the document, the drafting workspace on the user interface also has a write-in area for accepting alternative component text. If the user does not like any of the displayed components, the user may copy any of the components from the display area to the write-in area for editing. The system incorporates this write-in component in the final document as if it were retrieved from the database.

The user may search the original document database or another database for a particular document component. If the user is not satisfied with any of the retrieved document components and cannot find any desirable document component from the databases, the user may write in one or more passages as a document component. The system even allows the user to get document components intended for different document types and incorporate them in the final document. Therefore, the user can write combination documents such as a will incorporating a contract and a merge agreement including a stock option offer.

The system also allows the user to label all the components in the final document in one of several ways the user may choose (including no labeling). This system does not restrict the user in any way as to what substance will be in the final document while it guides the user with displayed component texts and help texts throughout the drafting process.

The method of drafting documents in accordance of the present invention includes the following steps:

(1) Constructing a document component database, each of the document components is, if necessary, embedded with text variables, which are to be replaced by the values that the user has entered. The database optionally has a body of help text for each of the document components. The help text may be built in the same database or in a separate but associated database.

(2) Retrieving a set of document components by using proper values of document fields, with or without using optional and additional retrieval criteria, and loading them in memory; extracting all text variables from each of the retrieved components and keeping them in program variables, and extracting an explanatory definition for each of the text variables if the database contains a field holding the definitions.

(3) Presenting the retrieved document components to the user on the user interface in a proper order, and displaying component texts in the display area, displaying each text variable and its definition in the input area, and optionally displaying the help text for each of the components on the help area.

(4) Selecting and editing the texts of the displayed components by the user, typing in values for respective text variables;

(5) Creating the document after the user submits the document to the central processing unit for processing;

(6) Displaying the generated document to the user in the user interface; and

(7) Optionally, formatting the document and further editing the document.

The system and method can be used to create legal instruments, certain business documents, and other documents. By adding and saving document components in the database, the user can save time in drafting documents because there is no need to carve detail language of the components.

The system is not intended to create perfect documents in each and every situation. The system is intended to create perfect document in some situations and can be used to substantially speed up the drafting process and make drafting much easier.

### BRIEF DESCRIPTION OF DRAWINGS

FIG. 1 shows the basic components of the Internet version of the document drafting system of the present invention;

FIG. 2 shows a database table in MYSQL for a sample document;

FIG. 3 shows a search window on the left and a retrieving window on the right on the user interface of the document-drafting system of the present invention;

FIG. 4 shows an expanded retrieving window for loading plural documents;

FIG. 5 shows a list of the documents resulted from a search and one document name being passed to the retrieving window on the right;

FIG. 6 shows the drafting workspace or page on the user interface of the Internet version of the document drafting system of the present invention;

FIG. 7 shows the search window initiated by clicking the insertion component at 2 on drafting workspace or page on the right;

FIG. 8 shows a list of document components found from a search, with titles returnable to the input box of title on the right.

FIG. 9 shows the correlation between the value of an insert point on the left window and the title value at the insert component at 10 on the right window.

### THE DETAILED DESCRIPTION OF THE INVENTION

### A. Hardware Components of the Document-Drafting System

If the drafting system in a standalone version is just a working computer operated by required software.

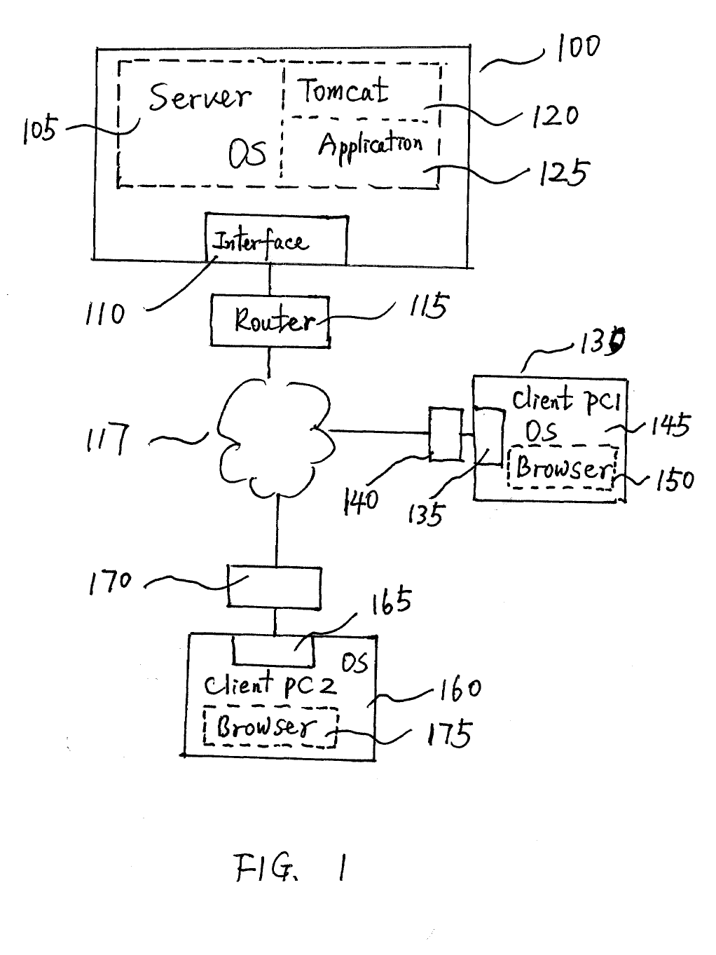

The Internet version of the drafting system comprises a server 100 and client computers 130, all of them are in a network so that they are able to exchange data using common data transferring protocol such as TCP (FIG. 1).

The server 100 is running an operating system 105 and is fully functional, has a network interface 110, and is connected to Internet 117 through a router 115. In one of the embodiments, the server is made of an Intel D945PNS motherboard with a Pentium D 940 processor operating by Fedora Core 6. Although the system came with a package of Java tool, a Java Development Kid (JDK version 1.5.11) is installed for compiling Java class files. In the ext folder inside the lib folder of Java Runtime Environment (/usr/share/jdk/jre/lib/ext), necessary jar files are placed. To handle file uploading, a package known jspsmartupload (or equivalents), which includes several class files, may be used. The server is installed with accompanied Apache Tomcat 5.5.15 and MYSQL 5.0.27. To allow Tomcat's Java class component to access the MYSQL database, mysql-connector-java.jar is placed inside the lib folder under the common folder of the Tomcat installation folder. The server application files of the present invention are placed in one single folder known as drafting. The source code files in JSP format is directly placed in this folder or sub-folders, and Java class components are placed in the folders under WEB-INF. The arrangement of folders, versions of Java components, and all jar files meet the requirements of the Tomcat application or be compatible with the Tomcat application.

The client computer 130 is also operated by its own operating system, has a network interface 135, and is connected to the Internet 117 through a router 140. The client computer 130 also runs a browser or a HTML rendering application so that the client computer is able to access the server 100 and access its the web pages according to supported HTTP protocols (e.g., 1.0, 1.1, and 1.2).

The FIG. 1 contains a second client computer 160 to show how this system is connected to plural machines. However, the second client computer is not necessary and it can be removed from the FIG. 1. Moreover, even the first client may be hosted by the same hardware sever by a loopback connection.

MYSQL database application is used in the Internet version of the document-drafting system. If speed and productivity is not an issue, commercial database can be completely dispensed with.

The application source files developed for this invention include JSP pages and Java class files. The JSP pages are located inside the application folder or its sub-folder. Inside the application folder, there are two folders, lib and classes. The lib folder may contain some jar files for run-time use. Within the class folders, there might be plural class folders with different names, each containing one class of compiled Java files. Under this working system, web page running on browser can access the database through the JSP pages or Java classes.

Whenever a JSP page is coded, it can be run directly under the application folder if it meets the requirement of the system and complies with JSP syntax standard. If a Java class file is developed, this file is compiled to form class file first before it is placed into a proper class folder. The Java class file is compiled using Javac from Java Development Kit (1.5.06), whose jre/lib/ext contains necessary API jar files.

### B. Creation of a Document Component Database

In one of the preferred embodiments of the present invention, the first step is to create a searchable database that stores document building blocks: document components.

### 1. Document Components

Document component is one or more paragraphs of language that can be regarded as a building block of document and conveniently referenced. A sale agreement, for example, may contain the following basic components.

(1) Seller agrees to sell a blue Honda and the buyer agrees to buy the blue Honda for $10,000.

(2) The seller provides a full warranty for a period of 5 years.

(3) This agreement is governed by the law of District of Columbia.

This example shows three basic document components. While each of the components is very simple, they may contain a lot more details. For example, the second component, the warranty statement, may contain a great deal of details. Moreover, any of the components may be divided into several subcomponents. The warranty component may be divided into three subparts: one subpart is about the duration of the warranty coverage, one subpart is concerned with how to get warranty service, and the other subpart lists other charges for incidental services that are not covered by the warranty.

Document components cannot be defined with absolute precision. A document component can be designated by the need to put all relevant language in one or more paragraphs, which may be conveniently referenced by a title, subtitle, paragraph or subparagraph number, or clause number. In a generic loan agreement, for example, the substance of the agreement is numbered according to certain numbering schema such as article, section, subsection, and paragraph. A business plan may also be numbered by section and subsection for the convenience of cross-reference.

A document component is not necessarily one paragraph. Rather, it is part of the document that addresses a specific topic. It is a preferred practice that the substance of the language within a document component falls within the scope of a component title. Some of the proper titles for the components in a loan agreement are the amount of loan, payment schedule, late payment, notice, remedies, limitations of damage, and governing law. It is obvious that it is a bad practice to put the substance of governing law under the amount of loan because governing law is outside the scope of amount of loan. If a latter part of the document refers to governing law, it has to refer to amount of loan section. This can confuse readers.

How document components are grouped depends to some extent upon the selection of component title. For example, it may be proper that governing law, litigation forum, and remedy are regarded as one single component under a broader component title: dispute resolution. However, if a subsequent part of the document needs to refer to a specific part of the language under dispute resolution, it is difficult to make such reference. Therefore, it is preferable to avoid using very broad component titles.

While there is a considerable degree of flexibility in defining document components, there are clear criteria for constructing document components. In the absence of special connection, a warranty statement for personal property should not be combined with language ordinarily used in Articles of Incorporation because they cannot be possibly related to each other. Two paragraphs cannot be grouped into one component if they are mutually exclusive unless their applications are contingent upon a condition and such condition can be written in the component. Two paragraphs cannot be grouped as one component if they are in conflict. If a paragraph is concerned with limitation of damages, it cannot be part of a document component providing unlimited liability. However, conflict and mutually exclusive texts may be placed as two separate components in a way of allowing the user to choose them as mutually exclusive options.

The best guidance in practice is that each of the numbered paragraphs in a generic legal form or instrument may be regarded as one document component. If a model document is not a legal instrument and is not numbered, it may be necessary to arbitrarily group paragraphs as components as long as a proper component title can be found to substantially cover the substance of the component and it is convenient for other part of the document to make reference. Breaking down a model document into components allows the user to add anything between any two components. Yet, the drafting system can preserve original style and document integrity of the document.

In a typical document, some components are more important, and affect the rights and obligations of the parties while other components do not. In this disclosure, the first type may be referred to as substantive components while the second type may be referred to as formality components. For example, the recitations in a contract generally will not directly affect the rights and obligations of the parties in the contract and may be omitted. Therefore, it is not necessary to provide many choices to the users. However, the drafting system may still provide plural choices to meet user's requirement for different styles and tastes.

For convenience, document title and any other basic information about the document such as source of origin, revision history, notes, and comments may be treated as a document component. This is just a choice of convenience. They may be not written into final document and their special status is indicated by the special value of a variable. In the alternative, such information may be placed in one or more special text fields of document component database if the database contains only one document. If the database contains plural documents, the special text fields holding the basic information for each document must be identifiable.

2. The Database Fields in the Database

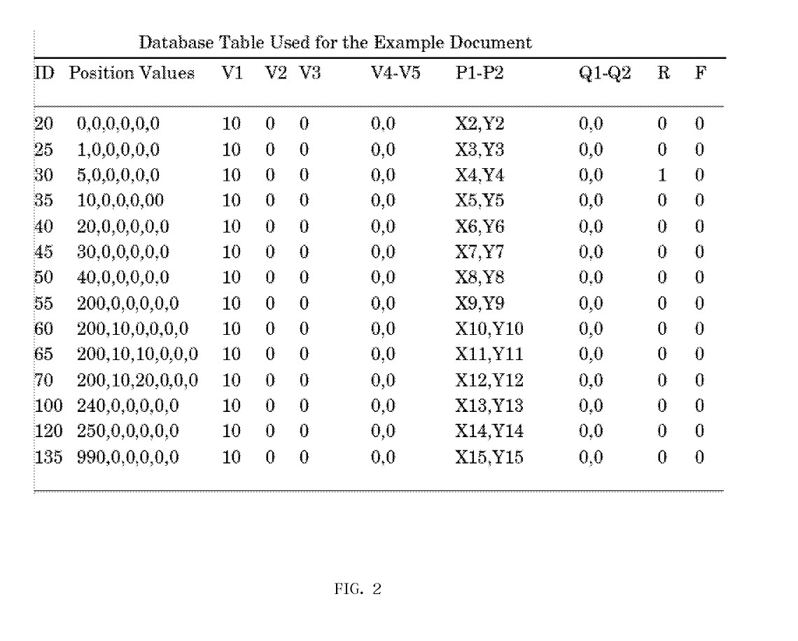

Database in this disclose means a collection of information organized in such a way that a computer program can quickly select desired pieces of data. Database contains fields, records, and files. A sample database table is shown in the FIG. 2. Since a great number of variants in a database table are possible, this figure is used merely to show the basic concept only. Not all fields are shown in the table. Other fields such as title-suppression flag are not shown. Database fields for holding information that is not inherent properties of the document such as status of insertion and deletion may be implemented by a program. It is specifically pointed out that all fields and variables discussed in this entire disclosure can be placed in this table. Database includes both databases like DBM used in Perl program and commercial database applications such as Access, FoxPro, MYSQL, and ORACLE. The component database contains the following database fields:

A field or variable for identifying the component. This field is referred to as component ID and its value is referred to as component ID value. Within document database, the ID value of any of the document components is unique. However, the document ID field may be replaced by another unique id field or a combination of plural other fields.

One or more position fields or variables. Those fields are used for determining the position of a document component relative to other document components within a document and their values are referred to as position values or position numbers.

One or more location fields or variables. Those fields indicate the physical location of the text of each of the document components in the database. Those fields are unnecessary if the texts of components are stored in the same table.

One or more document fields or variables. Document fields indicate document type, subtype, and specie, and their values are referred to as document values. A set of the document values defines a specific document.

One or more optional relation fields or variables. Those fields storing information about the relation between a document component and a nested component (e.g., subcomponent), and their values are referred to as relation values. Those fields may be combined with the position fields or variables;

An optional behavior fields or variable. Behavior fields control the numbering of document components, restarting numbering, or stopping numbering components in the final document; and

An optional format flag field or variable. Format flag field indicates the need for conducting local format of a document component in a document.

The document component database may be constructed in a number of ways that are commonly used in software industry. If the document is small, the database may be constructed in a text format. The text database contains a set of fields or variables concerns the text of a document component, as shown in the following format:

{ID, position fields N1, N2 . . . Nn, document type fields V1, V2 . . . Vn, component text location fields P1, P2, help text locations Q1, Q2, numbering directive R, format directive F . . . . }

The ID field or variable is used as a unique identity. Preferably, the values for a set of document components may be a series of numbers such as 1, 2, 3, . . . n−1, n or 10, 20, 30, 40, . . . n−10, n. Each of the values is used as an ID for each of the document components. The ID may be replaced by a combination of other field numbers if the database is constructed in a searchable table format such as Microsoft Access table and Microsoft Foxpro table. In building a large component database, document components, including the fields and component text, might periodically be entered into the database. Therefore, it is preferable, but not required, that a utility program is written to generate the values in this field and is able to renumber all of the components when a database table is finished. After the database is released, this ID for each document component is unique and can be used to identify the document component.

The location fields or variables, P1 and P2, are used to store the location information about the texts of document components. The component texts might be one long string, two-dimensional matrix such as text [symbol] , other structured file like email database, or a related database table. They are not necessary if component texts are stored in a related database table.

If the texts are placed in a structured file, they can be loaded into memory in runtime. If document components are stored in a continuous stream, P1 may be the start position and P2 may be the end position (or the length of the component). After the texts of components are built, the data may be saved and retrieved and the loading of the file does not change their locations in text[x]. The system is able to retrieve the actual text of the document component by using P1 and P2 values.

The best approach to tracking P1 and P2 values is to write and use a utility program that is able to read the text of components and write the data into a buffer text [symbol] and returns the absolute location P1 and the length P2 for each of the text of the components. When the program finishes processing the texts for all components, it also creates a small index table, which contains P1 and P2 for each of the component IDs. Then, the program writes the buffer text [symbol] into a database file. To retrieve the text of a component, the database file is loaded into a buffer in memory. When the retrieving unit wants to find the text for a component with known record id, it instantly get the P1 and P2 values from the indexing table, and copy the text starting at P1 for the length of P2. Thus, there is no need to search through the entire text file. This method may be used in a desktop application in a setting where commercial database is unavailable. It also has the advantage of save storage area.

If document components are stored in 2-dimensional character matrix (e.g., char text [symbol] , the location values for a component may be the index number of the row number of the text [symbol] Each of the text may be null terminated. Such data in text [symbol] may be saved in a file and retrieved. Only P1 is necessary because the length information P1 may be omitted. As long as the substance of the file is not changed, the loading of the file into memory each time gives the same result.

If the component texts are placed into other database tables, a record id may be used in place of P1 and P2, respectively. To avoid wasting storage space, multiple database tables may be declared with different storage size. A utility program may be used to evaluate the length of the component text and determines which table the component text should be stored. It may be desirable to use some extra space so that when a component is modified to increase length slightly or inadvertently, it has the margin to avoid overflow.

Of course, those are only examples because the database may be constructed in many different ways. Accordingly, the methods for associating them vary. Regardless of the actual method, the objective is that when the system retrieves a document component, it is able to find and retrieve the component text so that the system can display the component text on the user interface.

The document fields or variables, V1, V2 . . . and Vn, are used to store information on document type, subtype and species. The numbers collectively define a specific document. The number of required document fields (e.g., type, subtype, and species . . . ) depends upon sophisticated level of the database and the design of the database. For example, for the first field, e.g., the type field, the following meanings may be assigned: 1=contract, 2=lease, 3=will and 4=trust . . . The values in the second field may indicate specific type or subtype of documents. For example, for the document components with type value of 1 (e.g., a contract), the subtype values may have the following meanings: 1=sale of goods, 2=service agreement, 3=sale of intangible goods, 4=sale of special goods . . . It is possible to use additional document fields for further classifying document components. For example, there might be several kinds of sale of intangible goods: the sale of patent, sale of copyrights, and sales of secret formulation.

In the alternative, one field or integer variable may serve the function of all three document fields or variables: type, subtype, and species by using dividing ranges. For example, 1-1000 may be designated for lease, 1001-2000 may be for contract, and various ranges may be designated for other types of documents. Then, the values within any of the ranges may be designated for sub-type of document. The range, 1-1000, which is used for lease in the above case, can be further divided into smaller ranges, respectively, for residential lease (1-200), commercial leases (201-400), parking space lease (401-600), and land lease (601-800). The document fields or variables are necessary only when the database table contains components for plural documents that are defined by document values. The disadvantages of this range schema are that it is more difficulty to retrieve similar document components.

For a given document defined by document values, one or more fields are used to indicate the position of a document component within the document. This field may be used in combination with the relation field.

Each of the document components also has one or more fields (N2, N3 . . . and Nn) whose values indicate the relation between a high-level component and a nested component. The relation fields and position fields cannot be separated. In one implementation of the present invention, only one field is necessary. If the value is zero, it is the top level. If it is one, the component is a subcomponent, and if it is two, it is a sub-sub-component. A subcomponent may have its own subcomponent title. A high level component may have plural subcomponents. The subcomponents in a contract may be a subject that is important in the negotiation between parties. Position values and relation values may be stored in one database field in the form of “10,10,10,10,10” solely for convenience. They may be stored in five separating fields, too. The values are stored in different variables in processing the document in runtime.

There are one or more fields (for example, V4 and V5) to indicate whether any of the components in the vicinity are subject-equivalent. This field is used to indicate that those substantive components affect the rights and obligations of the parties or that the formality of components affects the look and style. Two subject-equivalent components generally are identical in position values and relation values. Despite the name of subject-equivalents, their component titles may still vary. For example, a subject is about warranty. Three subject equivalents components may have the following titles: lifetime warranty, limited warranty, and no warranty. When a user retrieves a set of document components, which are subject-equivalent, the values indicating this nature, are passed to the user interface. Therefore, those components are displayed in the display areas with mutually exclusive buttons. The user can choose one of them to be included in the final document.

Subject-equivalent components vary in, among others, detail levels and relative protection level to the parties. Therefore, it is preferable to use one or more fields to indicate their differences. The drafting workspace (generically a drafting page) on the user interface is designed to display subject-equivalent components according to their sizes or relative protection level for a party. If only one of the two fields is used to achieve the objective, different values or value ranges may mean different properties of the components. For example, 10, 20, and 30 means short, middle, and long, and 1, 2, 3 means, respectively, less favorable, neutral, or more favorable to a party. Thus, 11 could mean short and less favorable; 23 could mean middle size component with neutral terms; and 31 could mean long terms with less favorable to the party. No matter what scheme is used, the user interface must be programmed to understand the meaning of 11, 12, 13, 21, 22, 23, 31, 32, and 33. If a component in the same database does not have any subject-equivalents, the component must have a unique value (e.g., 0) so that the user can always retrieve it as default. They both may be stored in two separated database integer fields (e.g., V4, V5) in a commercial database table. They may be stored in one database field in the form of “10,10” for convenience.

Subject-equivalent components are indicated by the values of plural fields. If a particular subject in a database has 3 detail levels (the first values 1, 2, and 3) and 3 relative protection levels (the second values 1, 2, and 3), the combinations for the components are thus 1, 1; 1, 2; 1, 3; 2, 1; 2, 2; 2, 3; 3, 1; 3, 2; and 3, 3. Likewise, the components that do not have subject-equivalents must use unique numbers such as 0, 0 as default.

If a text string in the form of “XXXXXX” is used in lieu of database fields in the database table to describe the characteristics of document components, only two of those letter may be used: a letter at nth position may be used to indicate detail level while the letter at (n+1)th may be assigned to indicate the relative protection level of the component. Obviously, those methods of achieving subject equivalents can be implemented for other purposes.

Preferably, the document database also has plural help texts, each for one of the document components. The rules for storing component texts are applicable to help text except that Q1 and Q2 are used in place of P1 and P2. The other difference is that variable name-definition pairs may be line-terminated. The component text and the help text may be associated by a common index number such as record id.

The database may also have a renumbering directive, R. Different values may instruct the system to avoid numbering, to restart numbering from 1 or restarting numbering from a given number.

The database may also have a format directive, F. A particular value may instruct the system to format the text of a component. Formatting actions may include printing one or more table characters or line-feeding characters.

The word and phrases in each of the document components, which are likely vary in each specific situation, are replaced by text variables such as <attorname>, <saleprice>, and <sellername>. The design structure and spellings of the text variables are subject to the following limitations: each of them must be unique within the document in the database or among all documents in the databases that are used in combination to create a document. If the same text variable is used in plural locations, it must mean the same thing. Second, it is preferable to have some kind of tag such as “<” and “>” to indicate it is a text variable (unfortunately, it may be in conflict with HTML tags). Third, the overall structure and spelling are so unique that it is extremely unlikely that they are used as a word in a normal writing. Finally, it is preferable, but not required, that all text variables have same length. When the drafting system processes the document in the last step, all the text variables are replaced by respective text values that the user has typed in from the drafting workspace or page on the user interface. For example, if the user has entered “$200” for the text variable <salesprice>, all <saleprice>s are replaced by “$200” in the document.

Those text variables should not be displayed to user on the drafting workspace or page on the user interface because the user cannot understand them. Therefore, a definition for each of the variable name should be provided to the user on the user interface. If those variable name-definition pairs are stored in different database tables, they may be associated, for example, by a record number or index number with a particular document component. When a drafting system has plural types of documents that do not share text variables, index number and their ranges may be used to limit the application scope of the definitions. For example, the ranges of index numbers may be associated with different category numbers:

| Index Ranges | Category Id |
|---|---|
| 00000–09999 | 0 |
| 10000–19999 | 1 |
| 20000–29999 | 2 |

If certain documents need to use only definitions with category Id 1, it does not need to search for variable definitions for categories 0 and 2. In this case, there is no need to worry about potential conflicts between different definitions used for different categories of documents. Same definitions may appear more than once as long as they are for two or more categories of documents.

Optionally, one master variable name-definition may be used to store all potential definitions that a drafting system may encounter, and thus using index ranges is unnecessary. All variable names must be global in their application scopes, and an identical variable name may not have two different meanings in this case.

It is preferable that text variables are indicated by type for the following reason. A pronoun may be used as subjective pronoun, objective pronoun, possessive pronoun, and reflexive pronoun. “We” may be “our”, “us” and “ourselves”, depending upon where it is used. Since some of the variables may be replaced by pronouns which may have multiple forms. Therefore, to allow for better customization capability, a text variable for storing a person or object is indicated by a type flag that has values of s, o, p and r. Thus, <person> is actually written as <s:person>, <o:person>, <p:person>, and <r:person>, depending upon where they are used. If the person acts as a subject in the component text, <s:person> is used. If the person in the component text is an object, <o:person> is used. In creating a document, if the person is John Doe, John Doe will replace <s:person> and but “John Doe's” will replace <p:person>. Pronouns are rarely used in legal instruments. However, they may be used in business communications. More word forms may be indicated by additional values of the flag.

This will require a different form of words. It is preferable to construct table holding a word variants (“word variant table” or “word variant dictionary”) in the following format:

| Original | Subject | Object | Possessive | Reflexive |
|---|---|---|---|---|
| We | we | us | our/ours | ourselves |
| He | he | him | his | himself |
| She | she | her | her/hers | herself |
| John Doe | John Doe | John Doe | John Doe's | John Doe |

This dictionary can be large if it is intended to include all conceivable words, which are likely used in documents.

A verb changes its form, depending upon whether the subject is a plural or single. Therefore, the text variable for verbs may be written as <v:do>. This means that it is verb do. This “<v:” informs the system that its form varies, depending upon whether the subject is plural or single. If the subject in front of the verb is a single, it is replaced by “does”. If the subject is a plural form, it is will be replaced by “do”. A series of verb form values may be assigned, for example, for a single subject, for plural subjects, as a past form, and as past participant. Those multiple forms are not always necessary in all drafting situations. For example, when a system sends an email notification to customers, the verbs in the notice are most likely single form because the account is provided to an individual person.

Some of the verbs are irregular. Thus, it is necessary to build a table for verb dictionary as follows:

| Original | Single | Plural | Past | Participant |
|---|---|---|---|---|
| be | is | are | was/were | been |
| do | does | do | did | done |
| have | has | have | had | had |
| light | light | light | lit | lit |
| run | run | run | ran | run |

This verb dictionary can be large, too. Its use is discussed infra. For each of the document components, all text variables in a component may be kept in a string in a file, which can be read in run-time. This dictionary may be built in a table of commercial database if it is available.

Additional transformation is desirable in some cases. For example, the record for a document is {id: 45; n=30,0,0,0,0; v=10,0,0,0,0; t=PRINCIPAL OFFICE ADDRESS; f=incltype|incstate|agentadd} with its text being “The principal office of the <1:o> in State of <2:o> is <3:o>.” The text string “incltype|incstate|agentadd” are a collection of text variable names. The numeric number in the variable <1:o> corresponds to the order number of the text variable name in the variable list “incltype|incstate|agentadd”. During the processing, a transformation program transforms the above component text into “The principal office of the <o:incltype> in State of <o:incstate> is <o:agentadd>.” During the transformation, the status flag “o” is moved to the front.

This additional transformation may be useful in the case that the component is very long and the component uses same variables repeatedly. If the component text is very long, and the text variables appear many times in the text, use of such text variable list increases retrieving speed. The text variable list (e.g., “incltype|incstate|agentadd” or variable matrix holding the text variables) should hold all the text variables used by the component. In retrieving the document, the text variables are extracted and presented to the user on the drafting workspace on the user interface. If all text variables are embedded on a long component text, the retrieval program would have to search through the entire component to get the variable list. By using this variable list, the retrieval program does not need to search through the component text to extract text variables for presentment. However, it increases the processing burden because those shorthanded variables (such as <2:s>) must be replaced by actual text variables names and then further replaced by the values (or value strings) entered by the user. The other function of making this local variable list is that it can give a user or developer a clear picture of the required text variables. If a component has many pages long and contains plural text variables with a large number of variables, repetitively, it would be very hard to keep track of all text variables.

Document components are constructed in such a way that they allow the components to be numbered in the final document.

As stated before, anything may be stored in the component database as a document component as long as all parts of the system can recognize this special component and treat them accordingly. Some basic information such as document origin, version information, comments and notes may be stored in name-value pair format as a special component text.

3. Maintenance of Document Integrity within the Database

The document components for a document are just building blocks of the document. In ordinary cases, a user retrieves a set of document components using type and subtype and, if necessary, species, depending upon how the database is designed and constructed. While the database might have more document components than what is needed for the document, the user extracts only a substantially complete set of document components for use in drafting.

The integrity of document is maintained by the design of the database and the method of retrieving document components. Same document components intended for a given document should be generally be compatible with each other. In building the database table, incompatible components should not be placed in a database with same document values. For instance, if the type is contract and subtype is a bill of sales, all the document components under type contract are compatible with contract. They should contain no irrelevant materials unless they are specially marked for special purposes.

If the document database table contains only one set of document components, which constitutes a loan application, all components in the table must be compatible with each other. Any of incompatible components must carry special flag or be taken cared by the user during editing on the user interface. In this case, it is unnecessary to use document values for retrieving document components. The only thing required is to maintain their appearance order.

If the database table contains multiple documents, each of them is defined by a unique set of document values. The integrity of document components is maintained during retrieval because the components are retrieved by using a specific set of document values: type, subtype, and species. Retrieving document using the values (100,20,45) may get a loan application while retrieving a document using document values 1000,0,1 may retrieve an automobile-repairing manual.

The document components in a document not only must be proper for the document, but also be in a proper order. In a typical contract, an introductory clause proceeds a signature block. An executive summary in a business plan is generally placed at the beginning of the plan. For any document, the appearance order of the components is determined by the position values of the components that have the same document values. The position fields of document components for a document are assigned with proper values precisely according to their positions in the document. The values of the position fields may be 100 for the introductory clause, 1000 for a warranty statement, and 10000 for the signature block. By using a proper retrieving and sorting method, if necessary, those three components always appear in the right order: introduction, warranty, and signature. Some document components such as governing law and limitation of damages may be placed in any position within the document.

A uniform scheme may be used for all document types. For each subtype, the document components may be assigned with a range of 1-10000. The first 500 may be reserved for the system program use and the number above 10001 may be reserved for future uses. It is preferable that the position fields or variables should be assigned with nonconsecutive intervals (such as 10, 20, 30.) so that it is possible to add more components between any two components during editing.

4. Master Document Component Database and Search Function

As an option, a master database may be designed in such a way that it contains document components for many different documents. Because document components have different values in the document fields, the user can retrieve document components by using different document values including type, subtype and specie as retrieving criteria.

The primary purpose of building a master document database is to give user an option for searching for document components. Document components can be retrieved by searching words and phrases in their texts. If the database contains millions of commonly used components, the user has better chance to find document components sought. For example, the user can add a contract within a trust and insert contract components in the middle of the business plan. A sophisticated master document component database allows the user to retrieve two or more types of documents and have them displayed on the user interface. If the database is implemented as open source, it allows any user to enter new components as document and has it saved for use by other users.

In constructing a master document component database, it is preferable to implement it as normally database with one or more field values pointing to the physical location of the component texts in memory or a saved file on a hard disk. If the texts of document components are saved as a character stream, the start and end position of the text of each of the components can be used to retrieve the text. The physical location values need to be updated as the database components are added or removed. Therefore, it is preferable to use a utility program to build the database and to keep tracking of the locations of the texts of the components. If the database is to hold very large number of documents, a commercial database application such as MYSQL and ORACLE with plural tables with different storage size may be used.

Master database may be constructed as a reference source. It contains piece of model language for various purposes. A user can find some model language and edit it for self. In this case, the document fields are not necessary. It is important that the text can be searched. To improve efficiency, key words in the components texts may be indexed and saved in index files. For example, if a user wants to find a component concerning warranty in software media, the user might search the database using warranty and software. The system returns all components discussing to warranty and software on the user interface for editing.

If the database of the drafting system contains plural documents and the system may return plural found documents, it is preferable to return a list of hits so that the user can click on one of the hits to retrieve the document for editing. This step is not necessary for the desktop version of the drafting system and for drafting system that contains only a limited number of documents.

### C. Searching Document and Retrieving its Components for Editing

This step is to retrieve documents components to be displayed on the user interface for the user to edit. The detailed tasks performed by a retrieving unit in this step include the following:

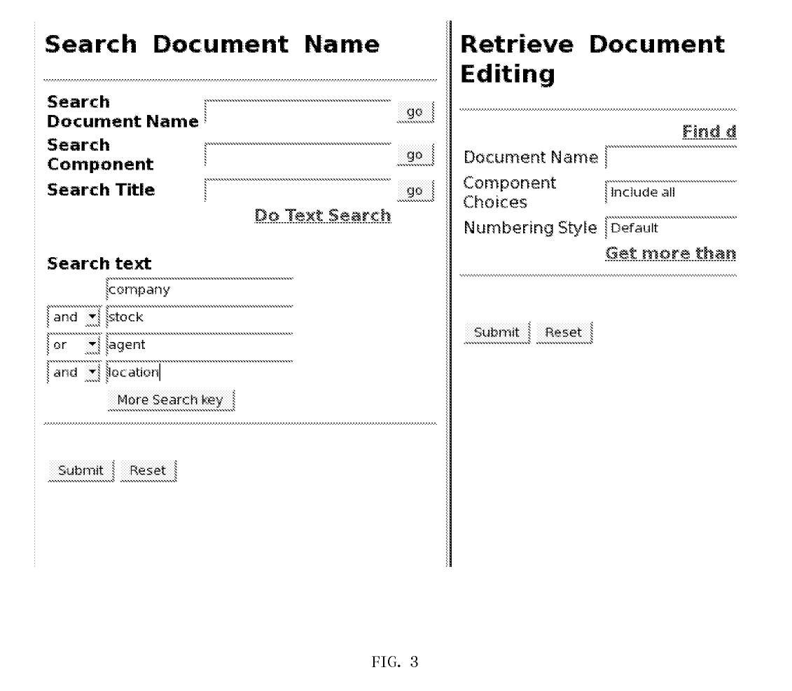

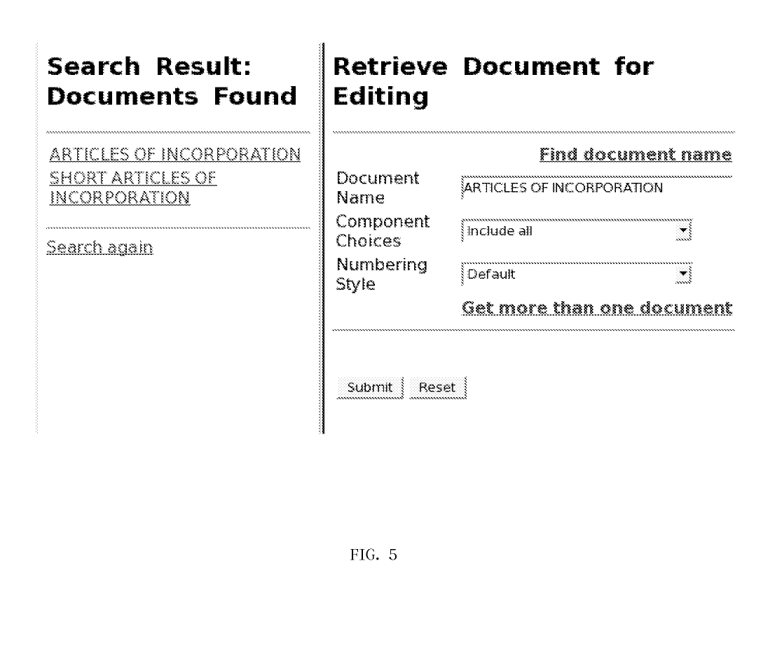

(1) In order to retrieve a document for editing, it may be necessary to find a document first. The search may be made using document name or numeric document ID, component name included in a document, document title, one or more words in document title or the text of document components (FIG. 3). The search program can automatically detect common name or numeric document values, and conduct search accordingly. The search window may also dynamically generate a search query for plural words (like “key1 or key2 and key3 . . . ) by clicking on “More Search Key”. Upon submission, the system then searches through respective fields in the database file or database table, associated database base table, or the memory buffer holding the documents and components. If it finds it, it returns the document for editing as shown FIG. 5

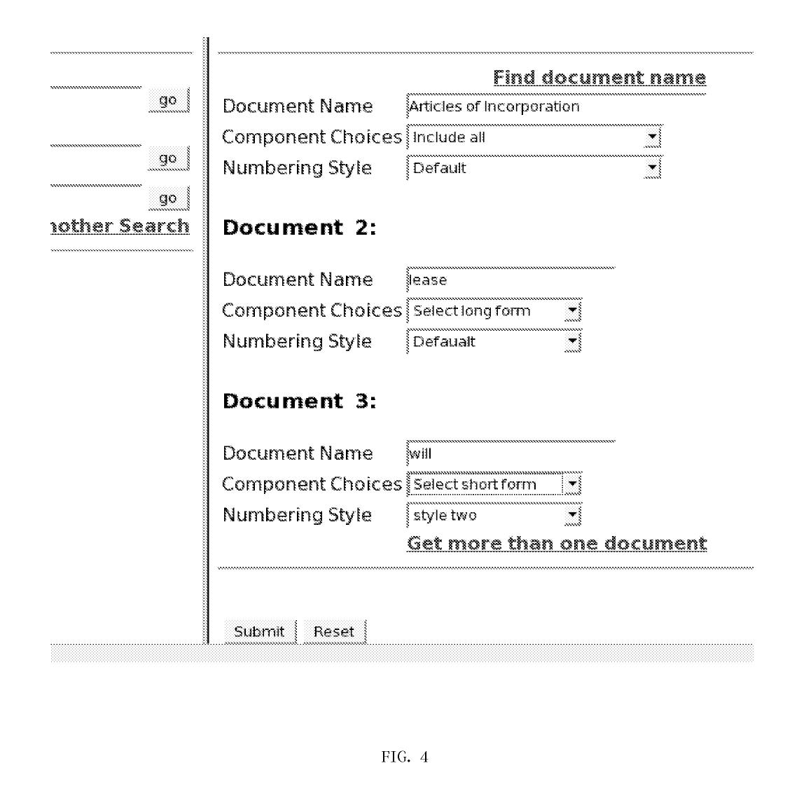

(2) Retrieving document components according to the retrieving criteria entered by the user on a retrieving window of the user interface (FIG. 5). The user may choose to include all subject-equivalent components, or just use a short form, median form or a long form and numbering preference. The retrieving windows allow the user to submit a request for retrieving plural documents by clicking on “Get more than one document” (FIG. 4). incltype|incoplaw|incstate

(3) Extracting all text variables such as incltype, incoplaw, and incstate

together with associated definitions indicating the meanings of the text variables; and

(4) Extracting the help text for each of the document components.

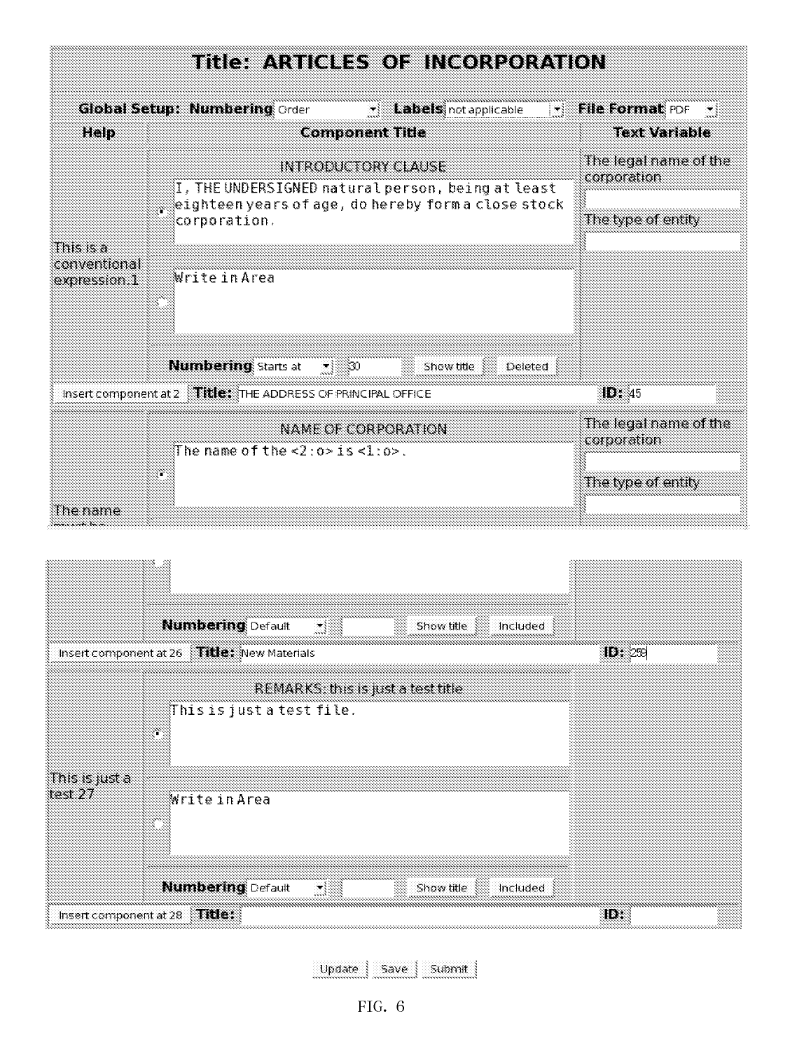

The help texts are extracted and displayed on the help area on the left side window of the drafting workspace for each of the components, as shown in FIG. 6.

If the component database is built for one specific document only, it may let the user retrieve all of the components. In this case, the user does not need to have the option to select document type. The user has flexibility to add a component, delete any of the retrieved components, and edit any of the retrieved components. If the database includes plural subject-equivalent components, the retrieving unit allows the user to retrieve components on the basis of the preference such as the details level and relative protection level for a party:

(1) Choosing a long form, a median form, or a short form.

(2) Choosing available subject-equivalents.

(3) Choosing detail level and relative protection level.

(4) Choosing other criteria.

Detail level and relative protection level of a component are two of the most important things in drafting business papers and legal instruments. In writing a bill of sales, it does not make sense to write a 20-page contract for an item sold for less than one hundred of dollars. On the other hand, a higher protection level and great amount of details are necessary in a contract concerning millions of dollars goods. Those options allow the user to decide how much details and relative protection the user wants. If the user is not pleased with retrieved components, the user can search for other components using different retrieval criteria. In addition to the options the user can exercise at this stage, the user can edit the text of the retrieved components without any restriction on substance.

The subject-equivalent components in the database may be indicated by different values of one integer field as shown below:

100: short and neutral

200: middle and neutral

300: long and less favorable

400: short and favorable

500: middle and neutral

600: long and less favorable

700: short and neutral

800: middle and neutral

900: long and less favorable

The retrieving unit must use the same scheme to convert query requests (a combination of words) into the proper numeric range for retrieving them. Obviously, the numbers may be arbitrarily chosen and the properties of the components associated with the numbers may be any important thing.

If two fields are used to characterize the properties of subject-equivalent components, the retrieving unit must understand the values of the two fields. In the example provided in the database section, the combination values are 1, 1; 1, 2; 1, 3; 2, 1; 2, 2; 2, 3; 3, 1; 3, 2; 3, 3. If the user enters a retrieval criterion for short components, the unit retrieves all three components with 1, 1; 1, 2; and 1, 3; if the user enters a criterion for all median components, the unit returns components with 2,1; 2, 2; and 2, 3; and if the user enters a criterion for long components, the unit returns components with 3, 1; 3, 2; and 3, 3. As pointed out previously, the system must retrieve all default components having unique value (such as 0,0) when there is no subject-equivalent.

If the database contains plural documents, the retrieval unit on desktop drafting system can prompt the user to enter all required retrieval criteria to get a complete document. Depending upon the design of the database and the capability of the retrieving unit, it may be necessary to specify subtype of the document. For any document that is defined by a set of document values, the detail level and relative protection levels may be implemented.

The retrieving unit may also be implemented, through programming code, in a way to allow the user to retrieve plural documents. This feature is useful in case where the user needs to create combination documents. For instance, a trust may incorporate a contract. In the simplest way, the program of the retrieving unit just allows the user to enter two or more retrieval requests containing the retrieving criteria, and the retrieving unit retrieves a substantially complete set of components for the first document according to the first request, and then retrieves the document components for the second document according to the second request. The retrieving unit then appends the second document to the first document with an indication of their respective titles. When two components are displayed on a computer screen, they look like two documents in a sequential order.

As an option, the user may specify which of the two documents is displayed as the first document. The integrity of each of the document is maintained in the database, during the retrieving process and during the editing by the user. The two documents may share text variables and make cross-reference to each other. In the simplest implementation, the user may add a reference using the position values of the component of a referred document. If the document is displayed on console mode, the user just types the position values (such as 1:100.20.30) in a referencing place, during the processing, the position values are converted into proper format such as Article Five, Section B, Subsection C. On a desktop GUI, the user needs to type in the order of the component. Since the order is associated with the position values, the processing unit can properly convert it into a reference. The GUI user interface on a desktop system may automatically assign position values when the user drags to a component in the user interface under a cross-reference menu.

When there are plural documents under drafting, each document may have its own global numbering scheme as defined by the value of a field in the document head or the first record with the lowest position numbers (since this record is not used as a building block, any field may be used for other purposes). A numbering directive field is also placed for each of the components. The numbering unit understands the meanings of the different values of the numbering directive, and numbers them accordingly until it hits a different value requiring a change in numbering behavior. Its values may mean stopping numbering, restarting numbering using a specific number, and stopping and resuming numbering using original component number. The user can change the numbering action for any of the components on the user interface. If the user places a stop directive on the fifth component, the numbering program numbers components from 1 to 5 and stop numbering from 6 to the end. This function may be used in some simple labeling methods, and may be disabled in the documents that require complicated labeling pattern.

When the retrieving unit retrieves document components for plural documents, the retrieval order is determined by the document values and position values. The first set of document components is retrieved in responsive to the first set of document values. The second set of document components is retrieved in responsive to the second set of document values. Within a set of the document components, the individual document components appear by their position values. Therefore, both of the documents are in a proper order. Since the document components in a master database may be randomized in their orders, it may be necessary in some cases to sort document components by document fields and position fields before the components are presented on the user interface for edits.

To change the appearance order of the components, the recording program first needs to modify the physical order of the components on the user interface. In order to allow for the creation of an internal reference, the position/relation values should be changed to the extent necessary for accommodating the change. If two first-level components are changed, the first numbers of (X,Y,Y,Y,Y) are renumbered in a proper order. If two components at the second level are swapped, the second numbers X of (Y,X,Y,Y,Y) for the involved components should be renumbered by using any interval or preferred interval of 10. Renumbering is unnecessary if (1) the reference names (such as Article One Section 2) are created solely by using the change of values without regarding the absolute values, (2) the reference names are created with all single/unpaired level numbers being ignored, and (3) the position values are not sorted in the entire application life. The rules are shown in the following example.

| Id | Position Values | Reference Name |
|---|---|---|
| 1 | 10,0,0,0 | Article One |
| 2. | 22,0,0,0 | Article Two |
| 3. | 30,8,0,0 | Article Three, Section 1 |
| 4. | 30,12,0,0 | Article Three, Section 2 |

Assuming, component 4 is moved to the component 2's position. The result would be:

| | Old | New | Reference |
|---|---|---|---|
| Id | Position Val | Position Val | Name |
| 1 | 10,0,0,0 | 10,0,0,0 | Article One |
| 4. | 30,12,0,0 | 20,0,0,0 | Article Two |
| 2. | 22,0,0,0 | 30,0,0,0 | Article Three |
| 3. | 30,8,0,0 | 40,0,0,0 | Article Four |

It should be noted that those single numbers for the second or subcomponent (12 and 8) are replaced by 0 because it would be pointless to label it as Section A when there is no Section B. However, single label such as “Section A” without Section B may be produced if there is a likelihood to add more sections afterwards.

Further assuming that the component 4 and 3 are swapped, the result would be:

| | Old | New | |
|---|---|---|---|
| Id | Position Val | Position Val | Reference Name |
| 1 | 10,0,0,0 | 10,0,0,0 | Article One |
| 2. | 22,0,0,0 | 20,0,0,0 | Article Two |
| 4. | 30,12,0,0 | 30,10,0,0 | Article Three, Sect 1 |
| 3. | 30,8,0,0 | 30,20,0,0 | Article Three, Sect 2 |

In this case, renumbering only the two numbers within the same first level number (e.g., 30) by using preferred interval (e.g., 10). Here, the number of 22 is changed into 20 solely to comply with a preferred numbering convention. It is obvious that a correct reference name may also be created by using a labeling program that creates the reference names by looking at a change of values (ignoring the absolute values). In this case, renumbering position values is unnecessary.

Another way of creating plural documents is drafting the documents by separating processes. The user can write one document a time and then put them together. The disadvantage of this method is that it is less convenient and the user has to maintain two working files. If this method is used, the user may have to add cross-reference manually after the user has finished drafting all documents.

When the system reads the text of the component, it checks for text variables (e.g., <ptyname>) that are marked by unique marks or tags such as < >. Whenever the system hits such tags, it copies the string content from the tags, e.g., “ptyname”, and finds its definition, “the name of party to the contract” from an associated database table holding comprehensive text variables and definition pairs. The definitions may be stored in the same table where the text variables are stored.

The variable names should be unique within the scope of their usage in the component database. If the document database is large, the number of variable names can be substantial. It is preferable that all variable names are unique cross all document components in the database. All text variables and their definitions may be listed in a separable variable name-definition table like a dictionary. In this case, the system can check the table for the definition of the each text variable and copy it to a temporary variable for later use on the user interface.

The retrieval system also gets help text for each of the components. Since the text of a component and the help text may be associated by the database record number or index number, it is easy to retrieve the help text.

### D. Extracting Text Variables for Use in Creating Drafting Workspace

The goal in this step is to find all text variables for the components and find their definitions so that the system can present them in the input area of the user interface FIG. 6). The system needs to take care of two things. First, the system cannot accept inconsistent and conflicting values for a given text variable. A text variable may appear many times within a component, and if all of them are displayed on input boxes of the user interface, the user may enter different values for same variable. Second, the system cannot use arbitrarily long string to name text variables. Some definitions may be very long, and it is inconvenient to use text variable names containing perhaps of more than 400 characters. To use short variable names, the system needs to build variable-definition table showing the pair-wise relation between variable names and definitions.

To prevent the user from assigning inconsistent values to a text variable, a log-and-search method is used to prevent duplicate variables from appearing on an active input box of the user interface. In one prospective embodiment of the present invention, two sets of matrix, or a global appearance table and a local appearance table, are used to store text variable names. The global table is used to store all text variable names for all components for all documents under processing, and the local table is used to store the text variables of the component under processing. The global table has a field for holding all text variable names and an optional field for holding respective value fields should be sufficiently large for holding all variables used by all components that a user likely encounters in using the drafting system, and does not have initial entry. The local table has a name field for holding text variable names of the component, a flag field for indicating the repeating status of variables, and a definition field for holding the definition of text variables. The local table should be sufficiently large for holding all variable names of the largest component. The detailed steps of determining whether a text variable name <s:variable> is a repeating variable is shown as follows:

(1) Searching the text of the component by finding “<” at position i and “:” at the position of i+2;

(2) If a text variable is found, copy the text variable name (from i+3 until reaching ‘>’, excluding “>”) to the text field in the local table;

(3) Searching the global appearance table for the same text variable name;

(4) If the variable name is found in the global table, the system marks this text variable name as a repeating variable by changing the value in the flag field in the local table, which will be passed to the user interface so that user interface displays it as non-editable variable.

(5) If the variable name is not found in the global table, it enters it into the global table at its alphabetic order position; and the system then marks this text variable name as a non-repeating variable in the flag field of the local table;

The system continues to search for next text variable and repeats steps 1-5. When the system finishes all text variables for the component, it creates the displaying area for the component so it can reinitialize the local variable for reuse. At the end, the global table contains a complete set of text variable names without any duplicate.

The local table for tracking the text variable names of a component is initialized after the system has passed text variable names, their corresponding flags, and their definitions to the user interface. In a desktop implementation, if only one local table is declared and used, it must send the content to the user interface before it can be reinitialized for reuse in processing next component. An alternative to this is that plural local tables are declared and used. In this case, their contents can be sent to the user interface after the system has processed all components. In an Internet implementation, the system uses name-flag-definition data from the local table in creating the user interface.

The retrieving unit also finds and presents text variable definitions to the user interface for display. Many of the text variables have global meanings. Examples are legal name of the corporation (See FIG. 6), contract title, a party in a contract, warranty duration, and late fee. Thus, it is useful to build a global variable name and definition table for holding such relations:

| Text variable | Definition |
|---|---|
| latefees | Amount of late fee |
| wanterm | Duration of warranty service |
| plainatt | Attorney for plaintiff |
| ptyname | The party in action |

It is preferable to build a comprehensive dictionary containing text variable-definition pairs. In this table, each of the text variable names such as ptyname in <ptyname> is associated with the definition of the text variable. All text variable names in a database must be unique within the scope of usage. It is preferable that variable names are unique cross all components databases that might be used by users.

Now the system fetches the definition from the variable name-definition table for each of the text variable names as follows.

(1) Opening the name-definition table containing the text variable names and their respective definitions, which have been sorted using the text variable names as a sorting key;

(2) Go through the local table containing text variable names;

(3) When the system hits a text variable, it copies the text variable and uses it as a search key;

(4) Search the name-definition table using the search key from (3);

(5) If the search key is found in the name-definition table, copy the definition from the definition field of the name-definition table to a cell in the definition column of the local table;

(6) If the search key is not found, enter a line such as “no definition is available” in a cell of the definition column of the local table; and

(7) Advance to next text variable name in the local table, and repeat the process starting at (2).

The system repeats the process for each of the local tables for components. At the end of process for each of the components, the local table contains text variables, the flag values, and their definitions.

The process of finding repeating text variables and the process for matching text variable names with their definitions should be combined as one single process. In other words, when the system copies a text variable name to the local table, it also uses the text variable name as a search key to search the variable name-definition table. If the system finds the search key, it copies the definition to the cell of the definition field in the local table.

When this process is finished, the system has a complete list of variable names in global table and optional unfilled value field. Each of the local tables contains text variable names, their flag values, and their definitions, those tables aid in the program in creating the drafting workspace shown in FIG. 6. The local table is used to send component information to the user interface for rendering. In desktop implementation, a similar global table is used to hold text variables, their values entered by the user, and variants generated by processing unit. In the Internet implementation, the global table is used only for keep tracking of appearance status. When the user interface send back variable names, repeating flag values, and variable values, the processing unit reconstructs a global table containing a complete set of the variable names together with different values arising from different forms of subjects and different forms of verbs.

### E. Presenting the Document Components in the Drafting Workspace.

A user interface is designed to display each of the document components according to its position values so that document components look like a complete and ordered document. In one of the preferred embodiments, the components of the user interface are shown in FIGS. 3, 4, 6.

The text of the retrieved component is displayed in the center column. There is at least one component text for each component subject or title. However, plural components may be displayed to the user as mutually exclusive. They are referred to as subject-equivalent components. By way of example, there might be three warranty clauses to be chosen for a sale contract. The three clauses provide different warranty durations, contain different levels of details, and provide deferent level protection. The user interface displays the three subject-equivalent components. The user may choose only one that is to be incorporated in the final contract. If the user wants to combine two of them for further editing, the user has to copy them to the write-in area for editing.

The help text, if any, is displayed in on the help window on the left next to the document component, and the meanings of variables are display in the input area on the right window of the user interface. The help texts may be provided as a series of hot links in the vicinities of the components to save space. This implementation is preferred for users who are familiar with the document, and use help only occasionally. The user interface allows the user to review the substance of the each of the document components and the whole document under formation so that the user can have a good picture of the document in progress.

In generating the editing environment in step 2 in the retrieval step, the definition is sent to the user interface for display. The text variable names, their definitions and their flags are passed to the user interface. So it is preferable to hide the variable names but show only the long definitions on the user interface. The system will have this long phrase displayed in the input area in a prompt format.

Many variables are used in many of the document components. Therefore, only the first one is showed as active variable in the input area of the user interface. If a variable has appeared in the previous display window, the variable definition and input box is inactive with an indication that this variable has been defined previously. A sophisticated user interface may be designed to automatically copy the values that the user has entered to those areas. This allows the user to know what the user has entered for those inactive variables. This technique is routinely used in user interface of Internet applications. This restriction does not affect the user ability to copy it and delete it in the write-in area of the user interface.

### F. Editing the Document Components by the User On Drafting Workspace.

The user may edit the components, subject to the minimum restrictions. In one preferred embodiment of the present invention, the text in the display window is editable so that the user may change and modify the text of the component. If the document component database is implemented with plural document components as subject-equivalents, and the user retrieves plural subject-equivalents, the user may choose only one of them for each of the components with subject equivalents. In order to combine two subject-equivalent components, the user may copy them into the write-in area and modify them for incorporation in the document.

In a preferred embodiment of the present invention, the user interface allows the user to write in a document component. If the user writes text in the write-in area or pastes text in the write-in area, the system will not use the original displayed components in processing the final document. This feature gives the user the full freedom in drafting document. Yet, the user has an opportunity to look at the model languages in the display area and can conveniently imitate it.

If the user chooses to write in his own language for any subject, the user may copy any of the displayed components to the write-in area without any restriction.

The user may also search a master database and find a component and insert it in a place designated by the user. When a new component is inserted, the user interface generates the necessary fields with default values. Since the text does not exist in the original document in the database, the user interface sends the text back to the processing unit with an indication that the text be included. The position values may be copied from the proceeding and or the succeeding components and modified by adding or reducing values so that the component assigned with the new position number fits in the context. The user may also indicate whether local formatting and renumbering is necessary to overwrite their default values in the original components.

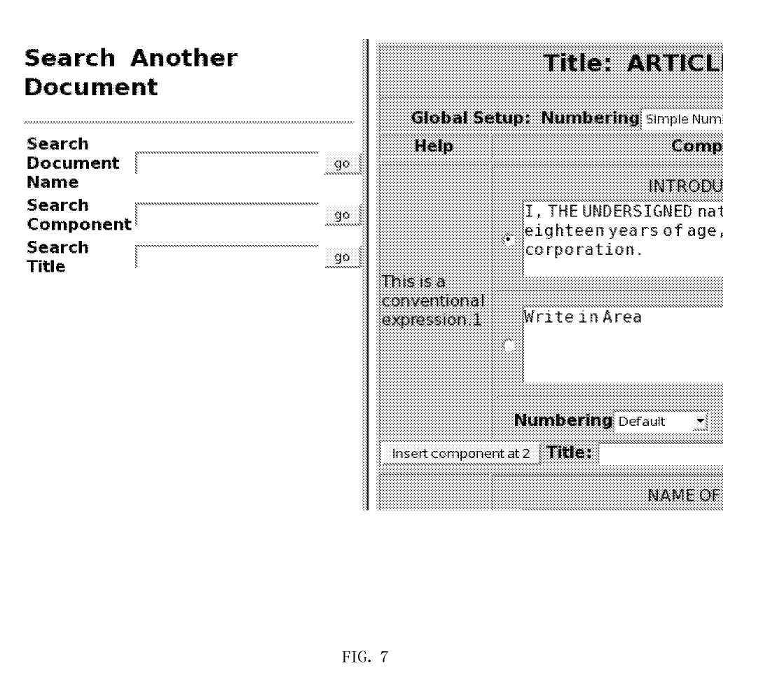

Another way of retrieving document components is by searching the document fields and text inside the component text. This function is intended to allow the user to find a component and add it in a document under drafting (See FIGS. 7,8,9). In retrieving a document component, the system also shows help text associated with the component in the help area (FIG. 6), extracts text variables from the component, finds the definitions for each of the text variables, and show the text variable names and their definitions in the input area of the user interface (FIG. 6).

When a component has plural subject-equivalent components, they are treated as a group by the retrieving unit. However, this does not prevent the user from deleting a linked component from the group and from adding a component between two components in the group.

The next task is to enter a value for each of the text variables displayed using definitions (using the input boxes on the right on the FIG. 6). The displayed long text is not the real variable name. The actual text variable, ptyname, is hidden. After the user enters a value by typing “John Doe” in the input box, the system associates ptyname with “John Doe”. All <ptyname> in the entire document are replaced by “John Doe” or its proper variants.

The user may delete a variable entirely if the user does not need it, and may copy any of the existing variables from one document component to the write-in area. The user cannot create new variable name. Obviously, the program may be designed to allow the user to define new variable for late use. Use of variables in many locations improves the consistency of the document.

The user may also incorporate cross-reference between two documents by using the method similar to the way of creating a reference within the Articles of Incorporation where Article Six makes reference to Article Seven, Section 1, Subsection (Appendix A and B). The only difference is that should include the document name (short name or full name) of the referenced document.

While document values and position fields are available in each component of the original database, those values may be overwritten on the user interface. This is necessary, for example, when the user searches and gets a document component from a master database so that document values, position values, and relation values are all out of context. Therefore, the user interface should be able to generate proper values by comparing the values of proceeding component and succeeding component.

In other prospective embodiment of the present invention, the user interface may be designed to allow the user to get cross-reference by dragging a reference point to a referred component in the displayed area, the user interface should get both document values, the position values, relation values (if applicable) of the referenced document, and use them to create referencing text such as “Section 4, Article 9 of the Lease” during the processing. On the Internet version, the cross-reference must be used only in the write-in area. So, the only thing the user needs to do is to type in an order number of the referenced component. The processing unit can automatically convert it into position values and correspondent article/section name or equivalent.

### G. Updating the Drafting Workspace

To update the drafting workspace, it generates the same page except that the system omits the deleted components and adds components that have been added. The system should be able to get the values for all variables and send them back to the user as default values. A detailed example is provided in the example that follows.

### H. Submitting the Drafting Workspace for Final Processing

When the user submits the edited documents from the user interface for processing, the submitted information includes all of the modified or unmodified field values, the texts of components, which may be modified or original, inserted text, including all field values that are not in the original components, and all the text variables, together with the values entered by the user. The text variable names and their respective values may be held in the global table in a desktop implementation. If the user interface is a browser of a client computer in a network, the text variable names and their values may be sent back to the server by name-values pairs. All of the field values can be sent to server in name-value pair or XML string. Upon final processing, the document is produced in

If the document components have been retrieved from a large database, it is more efficient to send all component texts for processing. If the components have been from a small document database, it is probably more efficient to send component ID or record ID so that the processing unit will find the text from the database again.

### I. Creating a Final Document

Upon finishing editing, the user then starts processing the document by pressing a submission button, which starts the running the software for processing the document. During execution, the processing unit uses the text of a proper component to write the final document.

(1). Selecting Component from the Display Area and the Write-in Area

If there is only one component entry in the display area and the user has not written in any text in the write-in area, the processing unit of the system uses the original component. Since the user has not edited the text of the document components, the processing unit may use the text of the original document component from the database. In this case, the system needs the component ID (or record_Id) and the values of the variables that may be modified by the user for the component.

If the user has edited the text of the document components, the processing unit uses the edited text to create a final document. In this case, the component ID is not useful in getting text but may be used to track variable names. In addition, the data that the user send back to the processing unit includes the text variable names and their values, document values, position values, relation values, the value of renumbering directive, and the value for local formatting. The processing unit uses all values that the user has selected and entered on the user interface page.

In the Internet version of embodiment of the present invention, if the user selects only a displayed component without using the write-in component, the system knows this selection together with the component Id.

For each document, hidden data governing the global formatting and numbering is printed at top of the drafting workspace on the user interface. Additional fields may be placed preferably at the bottom of the working area for each component signaling the need for an action inconsistent with global setup. Those selection buttons can be used to overwrite global numbering, conduct local format, and suppress a title of component.

If a component at the drafting workspace has plural subject-equivalent components, and if the user had not entered text in the write-in area, the processing unit uses the component the user has selected. If the user has not selected any of the subject-equivalent components, the processing unit may use the first component by default. When a selection has been made, the user interface sends to the server a value indicating the selected subject-equivalent component so that the processing unit knows which of the subject equivalents is used in writing the final document.

There are still two subtle versions of user interface. In one version, the user may be allowed to modify an exiting component and to write in a component. If the user has edited a document component, the system uses the edited document component in place of the original document components from the database. If the user has edited more than one subject-equivalent component, and has written in a component, the system may prompt the user to choose one of them before it is submitted to the processing unit for processing. However, if the user has written a component in the write in area, the system uses the write-in text, regardless of whether one of the components has been edited.

In the preferred embodiment, only the text in the write-in area is editable. The user may copy any of the existing texts to the write-in area, combine many subject-equivalent components and place them on the write-in area, or type in own text. The processing unit either uses the text of a selected component if the write-in area is empty or use the written-in text if the processing unit detects its value.

In all cases, the processing unit need to use text variable names and their values, document values, position values, relation values, the value of renumbering directive, the value of print flag for component title, and the value for local formatting directive for all the selected components. All of those values must be saved if the drafting workspace is saved for later processing.

The system may also check to see if the database is still available. Since the drafting files on the user interface may be saved and opened for late use. It is possible the database is not longer available. Therefore, it is preferable that the system should check for the version of the document and its availability in processing stage. If the document database is no longer available, the system has to use the text in the displayed document components to create a final document. Therefore, it is preferable to pass not only the edited and selected values but also the unselected values to the processing unit for final processing. When the database is not used in the final processing, the processing unit does not use component Ids.

(2). Processing Mathematical Computation

In processing the document globally, mathematical equations may be built into the document components as an optional feature. One or more of the document components may contain a mathematical model or equation, which will not printed in the final document. The model instructs the drafting system to compute a value using a few text variables. The model first needs to get the values for the text valuable from the user input. It then converts the values such as $124,000.00 into an integer or a float value and uses it in computing.

One of the computing models might be $<m:<monthrent>*<chargerate>>. Assuming the rent is 900 dollars and the charge rate is 0.05, the processing unit first replaces <monthrent> with 900 and <chargerate> with 0.05. The result is then $<m:900*0.05>. This unique mark “m:” indicate that computation is performed and the whole term is replaced by the result of computation. The computing program parses the inner data and converts 900 and 0.05 into integer and float, respectively. It then computes to arrive at 45, converts it into string “45”, and replace <m:900*0.05> with 45. The result could be $45. If many levels of computations are used, it is necessary to call the computing program many times.

There are other ways to conduct computation in the text of components. A computing model may be placed in a special component, which is designed by special position values of, for example, from 10 to 20. The equation may be written as <m:1result>=<monthrent>*<chargerate> in one or more fields (<m:1result>; <monthrent>*<chargerate>). If another component contains <m:1result>, which requires that the processing unit find the equation and compute the result using the equation.

For a document requiring several rounds of computations, it is preferable to use a unique notation or a special value in the database field to indicate the need to run the computing program and number of rounds. The computing program may be used, for example, to compute total contract price, total stock value, late fee, and loan amount.

The system then replaces the text variables with the values that the user has entered in the user interface. The text variables may be replaced by the values on a component-by-component basis or on a global basis.

(3). Using Correct Forms of Nouns and Verbs

Prebuilt database table (word variant table or variant dictionary) containing word variants may be used to find right form of words for text variables. For each of the nouns, it will have four or more forms: subjective, objective, possessive, and reflexive. Therefore, for each of the text variables, there are different forms of the words under different columns to the extent it has the form. From the flag notation in each of the text variables, the system knows which of the form it needs for replacement.

If a text variable, partygoers, is indicated with the variant flag o, and the user enters “we”, the system searches the value “we” through the dictionary table under the column correspondent to the flag o. The processing unit finds “us”, copies it and replaces the text variable with it. This implementation allows any of words to be represented by a text variable. If the system is unable to find the value string from the variant dictionary table, it follows the default rule. The user interface needs to return only one complete set of value strings for all the text variables (e.g., John Doe for <s:ptyname>, 50 for <o:contractprice> . . . ). If a value string has variants, the system needs to search the dictionary table to find a proper variant and replace the text variable with proper form. If a value string is a regular word, the system knows the proper variants (such as John Doe, John Doe, John Doe's, John Doe's). For example, if the user enters “John Doe” once, but it is used in many places in variant forms such as “John Doe” and “John Doe's”, the system should be able to take care of all.

The system may also use a prebuilt table for finding irregular verbs (irregular verb table). Since the verb status in a document component depends upon the count and tense, the text variable representing a verb needs to have a status indicator. For example, <v:do> may mean that, if the verb is used with a single subject, it is replaced by “does”. If the subject is a plural form, this variable must be replaced with “do”.

In creating the final document, the system may use the document components from database or from the browser. The implementation depends upon other factors. To reduce traffic burden, it is more convenient to use the document components from the database. However, if traffic is not a factor, it may simply send the edited document components for processing.

(4). Numbering Components and Using Subject/Component Titles

In processing the document, the system uses the position values and a user-selected labeling schema to number all selected or written-in components in the final document. In a well-labeled document, a classification word or division schema is used followed by a word or words reflecting number or order. The classification words include article, parts, subparts, section, subsection, paragraph, subparagraph, and provision. The word reflecting number or order of document components may be a series of words such as one, two and three, a series of numerals such as 1, 3, and 4, a series of letters such as A, B, C or a. b. c. There are many more similar words for denoting number and order. It is preferable that the system allows the user to define labeling method. If the user has assigned the following schema:

| Label Word | Numerical Values |
|---|---|
| Article | One, Two, Three and Four |
| Section | A, B, C, and D |
| Subsection | 1, 2, 3 and 4 |
| Paragraph | a, b, c, and d |

Then, the system would label the components like “Article One”, “Section A”, “Subsection 1” and “Paragraph a”. In another example, some documents may be labeled with a unique serial number such as Provision 1, Provision 2 . . . and Provision n. Some documents may be labeled by just order: First, Second, Third . . . and nth. Program for making order is in the public domain. Variations are obvious.

The system has a program for labeling all selected and written-in components. The document components in the database are placed in a consecutive order, and such order is preserved during retrieving process. Because the user may delete one or more components in some places and insert new components elsewhere, it is impossible to provide labels in prebuilt language. Also, when the user inserts a component found from a master database, its position values certainly are out of order. One way to take care of this problem is to modify the position values at the time of inserting the component or during updating process so that the consecutive order is maintained. This is why that all position values advance by a large interval. As a result of deletion of components, it is impossible to maintain the position values evenly spaced.

Those problems can be taken care of by a proper numbering program, which advances number when it detects a change in number. If the position values of the first field are 10, 20, 25, 25, 400, 120, 2000, respective for a series of components, the components are numbered as Article one, Article two, Article tree, Article four, Article five, Article six and Article seven. The labeling program will advance the number whenever it detects a change in the first position value relative to the position value of its next component, regardless of whether it increases or decrease.

This numbering program on the basis of value change also takes care of the out-of-order problem. The component with 120 as the position value is out of order. This happens because the user has found it from master database and inserted it on the user interface. By using this numbering program, it is unnecessary to adjust the position values of the inserted component. When the user inserts a component, the user bears the responsibility to ascertain that it is compatible with other components and make necessary editing, the system gives effect to its order. However, as stated before, the position values may be dispensed in some cases. In this case, the numbering is based upon the appearance order of each of the components and automatically takes care of inserted components. The position values may be changed by a JavaScript function on the user interface.

In the Internet version of the drafting system, a labeling instruction may be stored in the component record containing document basic information. This may be just one or more strings like “Doc-number=one|A|1|(A)|(1)”. The labeling program finds this string by the unique label and reads the character strings between two ‘|’ signs and understands the scheme. In this case, the first-level number (correspondent to the first number of the position value) is One, Two, Three . . . , the second-level number (correspondent to the second number in the position/relation values) are A, B, C . . . , the third-level numbers are 1, 2, 3 . . . , and the fourth level numbers are (A), (B), (C). . . . By using a similar method, the component label designation may also provided for each of the documents by “Doc-caption=article|section|subsection|paragraph|subparagraph”. By interpreting those words, the labeling program understands that the component at the highest level is referred to as Article, and a component at the second level is referred to as Section. In this example, the labeling program would add to the component title with a labeling term. It adds Article Two for a component at (20,0,0,0,0), Section C for a component at (20,30,0,0,0), and Subsection 4 for a component at (20,30,40,0,0). Thus, the final caption would looks like Article two—[component title] . . . Section C—[component title] . . . , Subsection—4 [component title]. If the final document is written according to a special file specification such as Rich Format Text, labeling program can also add indent control characters with its number being equal to the number of positive values in the position/relation fields (e.g. three indents for component at (20,30,40,0,0). If the labeling schema is not provided, the components are labeled with a simplest numbering scheme that is used by most word processing programs such as MS Word 6.0, and 2002. In printing a normal component title, it is not required to print all terms. When the labeling program prints a reference point for a particular component, it needs to print all terms like Article one, Section A, Subsection 1, Paragraph (A), Subparagraph (1) for a component at (10,10,10,10,10). For a component at (20,10,20,0,0), the reference terms, constructed in consistent with convention, would be “Section A, Subsection 2 of Article Two”.

The database may have a field for indicating if the component subject or title should be printed in the document. In some documents, the subject title of introductory statement and signature block should not be printed. If the titles are printable, the system still lets the user decide if the system prints all allowable titles for the components. If the user chooses to print titles for all qualified components, the user can still prevent the system from printing the caption for a particular component by changing the local title flag on the user interface FIG. 6. The button of “show title” can be swabbed. By clicking on it, it will display “no title”. Thus, the value associated with the flag variable is assigned with a value to suppress the title.

(5). Creating Cross-References

The ability to create cross-reference is a desirable optional feature. Within a set of components defined by document values such as type/subtype/species, one component sometimes needs to refer to another component. In a final document, one component might refer to another component by referencing: Subjection 1, Section A of Article Two. However, the component's position in a final document is unknown and they may change depending upon whether the user inserts or deletes any component. Therefore, the reference must be made to an inherent parameter in the database. Since the ID number changes in the course of development, it cannot be used as reliable reference. In comparison, position values for a given document are unique within the document, and are proper for internal reference. In order to maintain the accuracy of an internal reference, adjustment of the position values for the inserted components is necessary because the reference name is constructed using the position values of the referenced component relative to other components.

If the position values of a component are 20 (which is Article two) with sub nest level=2, it must be a Subsection. However, it is impossible to determine under which Section this component is. Therefore, it is preferable to use relation fields as follows:

| | |
|---|---|
| 20 | Article two |
| 20,10 | Article two, Section A |
| 20,10,10 | Article two, Section A, Subsection 1 |
| 20,10,20 | Article two, Section A, Subsection 2 |
| 20,20 | Article two, Section B |
| 21,1 | Article three, Section A |
| 2000,100 | Article four, Section A |

In this particular example, the number assignment is not based upon the absolute value of position value but a change in their relative values. The position numbers for components may be reduced into a character string. By using such scheme, the reference to 20, 20, 20 is unique (which is equivalent to Article two, Section B, and Subsection 2). A component may refer to another component by statement: “Subject to conditions provided in <1:20,20,20>, the first party shall have right to do X.” “<1:” is a unique mark for making a reference. In processing this statement, the system replaces the position values <1:20,20,20> with Subsection 2, Section B of Article two, arriving at the result: “Subject to the conditions provided in Subsection 2, Section B of Article two, the party shall have right to do X.” Much of the details on the numbering program are applicable in creating cross-references.

Since text variables may refer to each other, the text variables should be processed before the reference is processed.

In processing cross-reference to a particular component of another document, the system needs to know the generic name, actual title, and the position values of the referred component. The generic document title such as contract, lease or trust is indicated by the document values (which corresponds to a common name), and the actual document title is in the title field of the associated record that has the highest position values (e.g., 0,0,0,0,0).

(6) Other Optional Features

Many optional features may be added. They include grammar checking, spelling check, and conversion from a numeric string to number words (e.g., from 12 to twelve). They are preferable but not essential for practicing the invention in all situations.

(7). Handling Errors

In drafting documents, there are unlimited numbers of possible text variables and a computer program cannot take care of all unexpected text variables. Therefore, it is necessary to track errors. One of the possible errors is undefined text variable. If for any reason, a text variable is not given a value, the user interface should prompt for a value. The other way of handling such errors is to check for the value for each of the text variables during processing. Other potential problem is lack of help texts and lack of the definitions of text variables. However, missing help text and definitions of text variables is not fatal. Such problem can be fixed on the write-in area.

### J. Displaying the Created Document to the User

After the document is created, the system displays the document to the user in the user interface so that the user may decide to accept it or reject it. If the user rejects it, the user may continue to edit the same document components under the user interface by navigating back to the previous page. The user can redefine the values for all text variables, select different components, add desirable components, delete unwanted components, add or delete cross-references or internal references, change numbering behavior, add or change mathematical equations, and then resubmit the drafting workspace for a revised document. This process can be repeated without limit.

After the user first retrieves the document components, the user may want to know if the document components are the right type for the user's objective. Therefore, it is preferable to provide a function for review the document created by using default values of a set of variables. If the user wants to restart drafting a document using a different document components database or different set of components, the user needs to start from retrieving document components by using document values.

### K. Polishing the Created Document

Documents generated in accordance with the present invention are often presentable for use without further edits. Nevertheless, final documents may be further edited. However, it is the most efficient to edit the document components on the user interface. If there are dramatic changes such as change of a party's name, or change of the value of a text variable, it may affect the numbering and wording in many places. It is possible that five changes on the user interface may reflect fifty changes in the final document. After all changes are made on the user interface, the integrity of the document is maintained. It is not a good choice to add or delete components from the final document. Doing so would require the user to renumber components and fix internal reference errors manually. Final touch without changing document structure and wordings may be done directly on the final documents by using a word processor.

The steps are disclosed for the convenience of writing. Numbering components, using internal references, printing a time stamp, conducting mathematical computation, converting numeric strings, and converting cases are optional because they are not necessary in all documents. Even use of text variables is not always necessary in some documents.

In one of the preferred embodiment of the present invention, the document comprises a few document components. After they are retrieved and displayed on the drafting workspace on the user interface, the user can edit any word and phrase for them. It is preferable that those words that are likely the subject of modification and adjustment are highlighted so they can grab the attention of the user. The user then submits the edited components to the processing unit for final processing. This model is the most useful in the case where extensive modifications are expected or where creativity is encouraged, and the user needs model languages and minimum formality processing.

### L. Example for Writing Articles of Incorporation.

In this embodiment of the present invention, a document, comprising plural document components, is shown in Appendix A (the index and text bodies are printed together solely for viewing convenience). The steps for creating a final document are as follows:

1. Building a Database Table

The above text-form database is in text database (Appendix A), which is primarily useful in implementation without using commercial database application. When the values of the above text-form database are input into a standard database table, the results are shown in FIG. 2. The text-form database is used in a system having no commercial database application. For a system with a commercial database application, it may be viewed as an aide for building a fully searchable database table in FIG. 2. All of the fields shown in the text-form database may be entered into one single database table or multiple associated database tables.

For each of the components, the first number after id is a unique ID for identifying the document component.

The numbers right after “n=” are used to indicate its position of the component in relation to other components. After the text-form database is transformed into a commercial database table, those numbers are in fields of N1 . . . N6. For the convenience, all five numbers are stored in a single field of a database table in the form of “10,10,10,10,10” (Not all zeroes are spelled out in Appendix A). After the components are retrieved, the user can add or delete a component. On the window console version, changing the ‘id’ to ‘xid’ would remove the component from the final document. To add a component, the user just creates an entry like any of those in the Appendix A. After the components are retrieved, the order is controlled exclusively by the appearance order that is hidden from the user interface.

Those first three fields following “v=” are document values and they are used to define document type, subtype, and species. The last two “v” fields are for holding values for different properties of subject-equivalent components. The five numbers are split into two groups (like “10,10,10” and “10,10”), each of the group may be stored in one field of the database solely for convenience. Each of the components has only one document component and there is no equivalent component. Therefore, all of them have 0,0 values. The retrieving unit gets all of the components.

In the original form, the texts of components are stored in a text file. After the transformation, they are stored in the following database table:

Create component_body table (
record_id int,
help varchar(200),
text varchar(1000),
variable_name varchar(200) );

Multiple database tables would have been created for holding component texts with the lengths of 200, 2000, and 5000.

P1 and P2 are location values about the text for the corresponding component. They are not used in this preferred embodiment because the text of a component is just an accompanied field in the component_body table. Q1 and Q2, which are also optional, are location values about the help text for the corresponding component. It is necessary only when help texts are in a separated database file.

The string after “t=” is component title. The $ sign in front of the title mean that this title should not be printed in the final document (id=20 and id=25). The database table has a field for indicating whether the component title should be printed in the final document (not shown). The user can modify this value on the user interface.

The R field is for holding a renumbering directive and F holds a value for indicating whether formatting for the related component is necessary. A different value is also used as a numbering directive by special ranges (for example, 0 signals the system to number the paragraph; 1 signals the system to restart numbering, and value larger then 5 signals the system to restart numbering using the value). The user may change the value of renumbering directive for any component on the user interface. Another field is used on window console version to indicate whether the component text is a user-provided one. This is no longer necessary on the Internet version because each of the components has a write-in area on the drafting workspace on the browser (FIG. 6).

In this preferred embodiment of the present invention, text variables are coded indirectly. The text variables are put in a string after the notation of “f=”. They are placed into a proper field of the database table. This requires an additional transformation during the final processing:

{id: 30; n=1; v=10,0,0,0,0; t=NAME OF<u:incltype>; f=inclname|incltype}

The name of the <2:o> is <1:o>.

The numeric number, 1, inside <1:o> is the order number of the text variable following the “f=” string (also referred to as local variable list), while, o, means the form of noun. This means that the first text variable, inclname, is for the text field <1:o> and the second text variable, incltype, is for <2:o> and all terms like <2:X>. The processing unit copies, inclname, from the local variable list or its storage area, and place it inside “<1:o>” with “o” being moved to the front in place of “1”. The processing unit also copies, incltype, from the local variable list, and place it inside <2:o>” with “o” being moved to the position of “2”. Therefore, after the transformation, the text becomes: “The name of the <o:incltype> is <o:inclname>”.

The help texts are in the component text body table although it could have been stored on a structured file (both a linefeed delimited text file or one continuous string). The text variable names and their respective definitions may be as follows:

| | |
|---|---|
| agentnme | Resident agent's name |
| agentadd | Resident agent's address |
| . . . | |
| inclname | The legal name of the corporation to be formed |
| incsname | The short name of the corporation |
| incltype | Type of entity |

A short name-definition table is created for this embodiment. In creating the drafting workspace on the user interface, the system uses each of the variable names to find its definition, and print the definition above the input box for the variable.

2. Search for a Document and Retrieve all Components

In an Internet version of implementation, it is highly desirable that a user can search and find a document model as the starting point of drafting task. After the user finds a potential document, the user needs to read the details on a user-friendly drafting workspace so that the user may edit it for final processing, or discard it and continue to conduct searches.

In one of the preferred embodiments, this page contains both a search window and a document-retrieving window (FIG. 3). On the search window, plural search options are provided so that the user may search document name, component title (included in document), document values, and a combination of search keys in the title or text of components. On the document retrieving windows, the user may enter document name or document ID, may select whether the user wants to get subject-equivalent components in the document and choose any global preference features such as numbering styles (FIG. 4). The user may also retrieve multiple documents by clicking on get more than one document. One additional set of retrieving boxes is created each time the user clicks on this button shown on FIG. 4. If a document has two or more subject equivalent components, they are displayed among component text and the write-in input box on the drafting workspace shown in FIG. 6. Thus, if a component has two subject-equivalent components for the component 1, a user would see three large text areas: one for each of the two subject-equivalent components and one for the write-in text in similar style. The user may choose one of the three mutually exclusive radio buttons. Additional help menu may be provided for each of the subject-equivalent components by hot links (Not shown in FIG. 6). When a user clicks on the links, it shows a help message on a pop-up window.

If the user searches for a document by using a document name, it actually searches title for all records with position values of 0,0,0,0,0. The record with position values of 0,0,0,0, is always the start record containing the basic information about the document including its title. The text field may contain document sources, revision history, version information, and labeling instructions such as “Doc-label=one|A|1|(1)|(a)”. Each of the information is labeled with special tag so that program can find them. This labeling instruction informs the program to label the component at the first level with “one, two . . . ten”, the second level with “A, B and C”. The rest is self-explanatory.

If the user searches component title, the drafting system searches through all of the title fields in the associated the component_body table. When it finds a match, it returns a document name, which is in the record that has the same doc-value1, doc-value2, and doc-value3, but has the position values of 0,0,0,0,0. The program is designed to understand numeric document values, the user may also use document values search. It just searches using doc_value1, doc_value2, and doc_value3 (collectively, they are document values) to do the search. In addition, the search page also allows the user to do text search using words and phrases. This search menu allows the user to enter more keywords in boxes by clicking on “More search key” (FIG. 3). The expanded boxes come with a dropdown box that allows the user to choose between “and” and “or”. Thus, after having clicked on “More search key” three times, the user actually is able to conduct the following search:

[keyword1] and/or [keyword2] and/or [keyword3] and/or [keyword4]

Upon submitting the filled search form or pressing the related search button, the system returns a list of found documents. When the user clicks on the document, the browser copies the document name/with the underline document values into the input box for the document name on the retrieving window on the right. The user can make a choice from a dropdown among the menu on subject-equivalents and numbering style. After the user has filled the document retrieving form and submits it to the system, the drafting system returns a drafting workspace on the user interface as shown in FIG. 6.

The document components in Appendix A are presented to the user as shown in the FIG. 6. For each of the components, the help text is displayed in the help box. The component text is displayed in the center column of the user interface. The texts of all subject equivalents also displayed parallel to the write-in area, and the first default component text area. The text variables associated with the component are displayed in the input area on the right for the component.

3. Editing the Document Components on the Drafting Workspace or Page

The use can view the help menu to understand the component text, select any of the subject-equivalent components, and copy any of the displayed text into the write-in area for editing. The user may delete any of the components by selecting a box for deletion, search for a component and add it between any of two components, and make an exception to global numbering scheme for a particular component (e.g., skipping one component or restarting numbering with a different number).

On the preferred embodiment of the present invention, there are inserting and deleting menu between any of two components (FIG. 6). When the user clicks on the “insert component at 2” button, the user interface opens a search window on the left of the user interface (FIG. 7). The user may conduct a search using document name/document values, component name or component id, and keyword in document title or document title, or component text. All search capabilities shown in FIG. 3 may be provided here except that results are listed on the basis of individual components. Upon submitting the search query, the system searches through the master database containing plural documents and returns a list of found components. If it hits a document, all components of included in a document are presented on the results. In generating the search page, the system passes the information such as the insertion point on the page to the search page so that the search page knows where the insertion is to be made later.

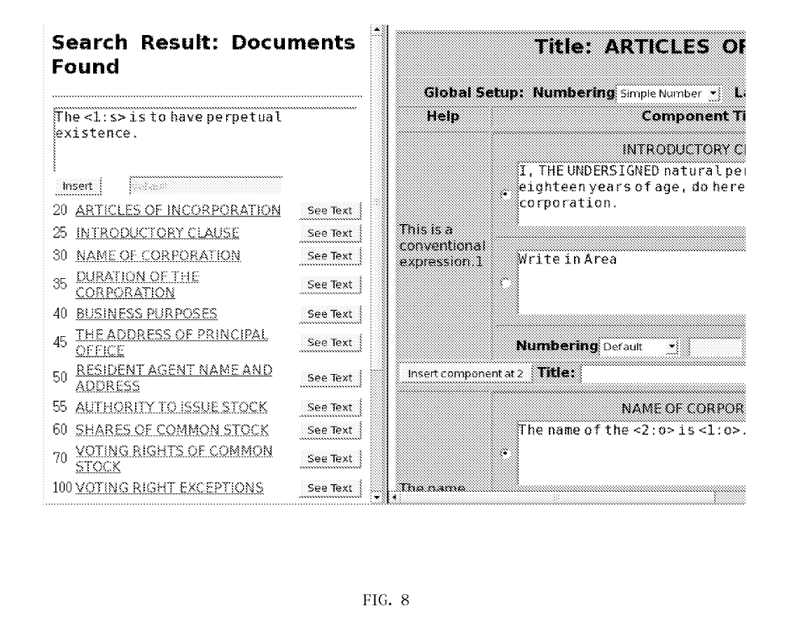

From a list of the found document components or entries, if the user clicks on any of them, it causes the browser to copy the title of the component into the input box next to the insertion point. If the user clicks on “Name of Corporation” on the left, this name will appear on the input box for title of “Insert component at 2” on FIG. 8 (not shown). In addition, the search window on the left also has a display window and each of the found entries has a “see text” hot link. If the user click on “see text”, this action causes the server to display the text on the display window above. When the user clicks on the “Duration of the Corporation”, the text of this component is shown on the above text box.

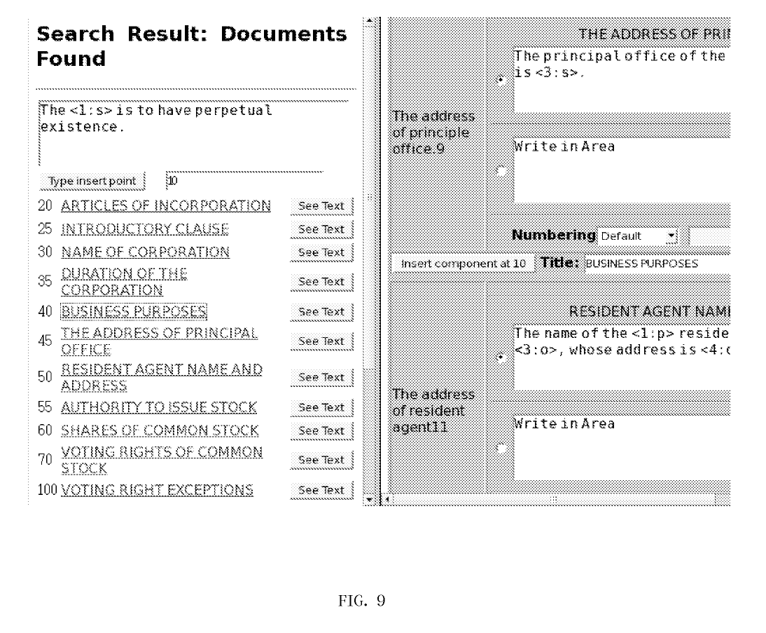

While this search window has been generated for the insert component at 2, it is possible that the user wants to insert something into a different document position such as “insert component at 10”. When the user clicks on the “Insert” button on the left, this action will cause the button to change its name to a prompt, “Type insert point” (FIG. 9). The user then types 10 in the box next to the prompt. Afterwards, if the user clicks on any of the title such as “Name of Corporation”, the name and its ID are copied to the title box and the id box for the insertion point at 10 (The id box is not visible in FIG. 9, but it appears on FIG. 6). This allows the user select any of the component titles to be inserted at any insertion point.

The user may select any of the setup buttons including global setup buttons and local setup buttons, and change any of the values, which are open to the user. The user can enter values for each of the text variables. For the example, the user is prompted to enter the following data:

The legal name of the entity to be formed:

Inclname=John Doe Holdings, Inc

The short name of the entity:

Incsname=Corporation

. . .

Name of the incorporator:

incname1=John Doe, III

Address of the incorporator:

incaddr1=7777 Nostreet lane, Nowhere city, NS 77777

At the bottom of the user interface, the user may choose to update the document components for further editing or submit the drafting workspace for final processing, or save it for later editing. The user may also choose to insert a blank component. There are two ways to add a blank record. In one method, an additional button is provided that clicking it will cause a JavaScript to write a special value “status=‘blank’” to the variable name for status information. The other way is that the database contains a blank record (“Blank Component”), which is always retrieved by default. The user can change its name into what the user wants on the input box on the right.

5. Updating the Drafting Workspace

If the user chooses to update the document components on the drafting workspace or page, the server generates a new drafting workspace on the user interface with all original data except that it does not contain components which have been marked for deletion, but contains the components that have been inserted. In rewriting the components on the drafting workspace, the browser sends back all user-provided name-value pairs to the server for use in reconstructing a new drafting workspace on the user interface. The data includes the values used by global setup and the local setup.

The drafting system uses a plural sets of variable names (such as cp_status1, cp_status2 . . . cp_statusj; pcno_s1, pcno_s2 . . . cpno_sj; and pcno_p1, pcno_p2 . . . cpno_pj) as the variable names for all editable data such as radio button, input text for the write-in area, format flag, renumber flag (and associated number or value), and component title flag, except the text variables. The fields that do not carry user data such as insertion and deletion status are printed as hidden data. Each of the components has status variable in hidden data, which contains its appearance order in the drafting workspace in an odds number. The status variables are like cp_status1, cp_status3, cp_status5, . . . cp_status15. Even numbers are reserved for insertion purposes. When the user inserts a component with a database record_id=505 between components 5 and 7. The newly inserted component is marked by the browser as “cp_status6=‘inserted’” or “cp_status6=‘505’” (where 505 is record_id. Since there are only four statuses: inserted, delete, original, blank, the server can easily identify the insertion status by a database record_id). In updating the drafting workspace, the server checks for all status values for all entries (1, 2, 3 . . . 15) and creates a new drafting workspace according to the following rules:
a. It goes through all status variables j=1, 2, 3 . . . n, and check for the value of the status variables. If a status variable associated with component j has “cp_statusj=‘deletion’”, the server does not print this component in the new drafting workspace. It just skips it completely;
b. For component j whose status variable has the “cp_statusj=‘original’”, the server prints the text area using the text value from the correspondent database table; if the write-in area has a value, it prints the value back to the corresponding write-in area; and if the radio button has a selection other than the default value, the server marks the same button. All of those variable names and their values are associated by the index number.
c. When the server encounters an inserted component (cp_statusj=‘inserted’” or cp_statusj=‘505’”) at an even index number, it assigns a new position values in the format of X,X,X,X,X and overwrite the existing values from its database table. This numbers are extrapolated according to the position values of the preceding component and the position values of the succeeding component as follows:

| Case | Preceding | Inserted | Succeeding |
|---|---|---|---|
| 1 | [10],0,0,0,0 | 15,0,0,0,0 | [20],0,0,0,0 |
| 2 | 100,10,[0],0,0 | 100,10,5,0,0 | 100,10,[10],0,0, |
| 3 | 100,10,[20],0,0 | 100,10,25,0,0 | 100,10,[30],0,0, |
| 4 | [200],10,40,0,0 | 250,0.0,0,0 | [300],10.10,0,0 |

The rule is that the server copies all identical numbers until it encounters a first pair of unequal numbers, use their average of the first two unequal numbers, and fill the rest of the numbers with zero.
d. The inserted component must always be marked with cp_statusj=‘inserted’” or “cp_statusj=‘505’”, indicating that it has been inserted. The sever keeps track of this status and preserve the extrapolated position values in all subsequent updates. In the next updating, the same component having cp_statusj=‘inserted’” will have an odds index number (e.g., 1, 3, 5 . . . or 15). This unique combination tells the server that it has been inserted previously. This component should be treated as cp_statusj=‘original’” except that the server will use the document position values from browser. The server keeps track of the position values all the time for inserted component.
e. The server encounters a cp_statusj=‘blank’”, it uses the same rule in treating normal inserted component except that it does not have any text from the user. The user will set all values for title flag, renumbering directive, and format flag in an updated drafting workspace.
f. When a component is deleted, there is no need to adjust the position values.
g. In response to an updating request or final submission, the system sends all use-input values for each of the text variables. For each of the components with a record_id, the server can find all of the text variables (for example, the record 25 has text variables inclname and incltype). So, the system can use the variable names from the variable list to get their values that the user has provided. The system prints the user-provided values into the input boxes of respective text variables. For a newly inserted component and blank component, there is no need to check for the values for any of the text variables.
h. In a preferred embodiment, the server may use the log-and-search method to find repeating text variables. If a text variable is found to be a repeating one, it may be printed as a disabled/inactive text variable on the drafting workspace.
i. The drafting workspace should also contain a submission button, an update button and a save button for later use.

6. Final Processing to Create the Document

In processing the document, the processing unit of the system replaces the text variables “< >” with the values entered by the user from the user interface and all components are labeled with a number according to a selected numbering schema except that it is changed by a directive for a component. The resultant document is shown in Appendix B.

The system conducted mathematical computation in Article Five, Section 1. It changed character cases for some terms. Article Seven is for write-in only. The drafting workspace on the user interface allows the user to add any component at any place and to delete any of the components at any place. The user may copy and edit any thing. The drafting system produces a document accordingly.

In some cases, a user may want to change the order of the components. It is preferable to provide the reordering function in a prospective embodiment. What to achieve at the browser is to change all index numbers for two sets of variable names. For example, if a component with a set of variable names, pc_status_j, pcno_sj, pcno_q_j, pcno_p_j, is swapped with a set of variable names pc_status_i, pcno_s_i, pcno_q_j, pcno_p_i, where i!=j, a JavaScript function is designed to get all those variable names and change their index numbers in pair-wise. In updating drafting workspace, the server will print them using their index numbers, thereby affecting the change. Global reordering is also possible. A JavaScript function may be designed to rewrite index for all variable names in the order of (1, 3, 5, . . . n). In an input box, the user is prompted to enter the new component order numbers in a sequence. If the user enters 15, 9, 3 . . . n in the box and clicks a button to run it, the JavaScript function first gets the variable names pc_status_{—}15, pcno_s_{—}15, pcno_q_{—}15, pcno_p_{—}15 and change the index number from 15 to 1, thus resulting in pc_status_{—}1, pcno_s_{—}1, pcno_q_{—}1, pcno_p_{—}1. It then gets pc_status_{—}9, pcno_s_{—}9, pcno_q_{—}9, and pcno_p_{—}9, and change them to pc_status_{—}3, pcno_s_{—}3, pcno_q_{—}3, and pcno_p_{—}3. The JavaScript function repeats the process until it processes index numbers for all variable names. In the alternative, swapping order between two components can be achieving by changing the values between one set of indexed variable names and its correspondent indexed variable names (e.g., between indexes 15 and 1). This operation is subject to the restrictions imposed by relation and position values of the components.

It is also preferred that all component titles are shown in an editable input boxes so that a user can change them.

In those exemplary embodiments of the present invention, specific components, hardware parts, arrangements, and processes are used to describe the invention. Obvious changes, modifications, and substitutions may be made by those skilled in the art to achieve the same purpose of the invention. The exemplary embodiments are, of course, merely examples and are not intended to limit the scope of the invention. It is intended that the present invention include all other embodiments that are within the scope of the claims and their equivalents.

APPENDIX A
Sample text-form database table for a sample document

```
    {id: 20; n=0; v=10,0,0,0,0; t=$TITLE; f=<t2> | ins101fn | inclname | <r1>*a}
    <1:a> <2:u> OF <3:u> <4:a>
    {id: 25; n=1; v=10,0,0,0,0; t=$INTRODUCTORY CLAUSE; f=inclname | incltype}
    I, THE UNDERSIGNED natural person, being at least eighteen years of age, do
hereby form a close stock corporation.
    {id: 30; n=5; v=10,0,0,0,0; t=NAME OF <u:incltype>; f=inclname | incltype}
    The name of the <2:o> is <1:o>.
    {id: 35;n=10; v=10,0,0,0,0; t=DURATION OF <u:incltype>; f=incltype}
    The <1:s> is to have perpetual existence.
    {id: 40;n=20; v=10,0,0,0,0; t=BUSINESS PURPOSES;
f=incltype | incoplaw | incstate}
    The purpose of the <1:o> is to engage any lawful act or activity for which <1:s>
may be organized under the <2:o> of <3:o>.
    {id: 45; n=30; v=10,0,0,0,0; t=PRINCIPAL OFFICE ADDRESS;
f=incltype | incstate | agentadd}
    The principal office of the <1:o> in State of <2:o> is <3:s>.
    {id: 50; n=40; v=10,0,0,0,0; t=RESIDENT AGENT NAME AND ADDRESS;
f=incltype | incstate | agentnme | agentadd}
    The name of the <1:p> resident agent in <2:o> is <3:o>, whose address is <4:o>
    {id: 55; n=200; v=10,0,0,0,0; t=AUTHORITY TO ISSUE STOCK; f=incltype}
    The <1:o> shall have authority to issue Common Stock in accordance with the
following.
    {id: 60; n=200,10; v=10,0,0,0,0; t=SHARES OF COMMON STOCK;
f=110000 | 1.00 | ins101fn}
    <1:c> (<1:g>) shares shall be Common Stock, and the par value of each of such
shares is <2:c> Dollar(s) ($<2:a>), amounting in the aggregate to <c:<m:<1:a>*<2:a>>>
Dollar(s) ($<m:<1:a>*<2:a>>). The preferences, limitations and relative rights of the
Common Stock shall be as hereinafter set forth:
    {id: 65; n=200,10,10; v=10,0,0,0,0; t=DIVIDENDS OF COMMON STOCK;
f=incltype}
    The holders of Common Stock shall be entitled to share equally all dividends
declared and paid by the <1:o>.
    {id: 70; n=200,10,20; v=10,0,0,0,0; t=VOTING RIGHTS OF COMMON STOCK;
f=incltype | 1:240}
    The holders of record of Common Stock shall have one vote, on all matters upon
which stockholders of the <1:o> may vote, for each share of Common Stock held by them,
except as such rights are modified in <2:l> hereof for cumulative voting rights in the
election of directors of the <1:o>.
    {id: 100; n=240; v=10,0,0,0,0; t=VOTING RIGHT EXCEPTIONS}
    (to be added from the user interface).
    {id: 120; n=250; v=10,0,0,0,0; t=ELECTION OF THE DIRECTORS OF BOARD;
f=incltype | InitlDir}
    The initial board of directors consists of one director. Before an election takes
effect, <2:s> will serve as the initial director of the <1:o>. Election of directors need not
be by written ballot.
    {id: 135;n=990; v=10,0,0,0,0; t=MAILING ADDRESS OF INCORPORATORS;
f=incname1 | incaddr1}
    The name and mailing address of each incorporator is as follows:
        <1:o>
        <2:o>
    Signature:  , Date:
```

### Appendix B—Result Document Created for the Document Component on Appendix A.

ARTICLES OF INCORPORATION FOR JOHN DOE HOLDINGS, INC

I, THE UNDERSIGNED natural person, being at least eighteen years of age, do hereby form a close stock corporation.
ARTICLE ONE: NAME OF CLOSE CORPORATION
The name of the Close Corporation is John Doe Holdings, Inc.
ARTICLE TWO: DURATION OF CLOSE CORPORATION
The Close Corporation is to have perpetual existence.
ARTICLE THREE: BUSINESS PURPOSES
The purpose of the Close Corporation is to engage any lawful act or activity for which Close Corporation may be organized under the Corporate Act of Nostate.
ARTICLE FOUR: PRINCIPAL OFFICE ADDRESS
The principal office of the Close Corporation in State of Nostate is 9999 Nostreet Lane, Nowhere city, NS 99999.
ARTICLE FIVE: RESIDENT NAME AND ADDRESS
The name of the Close Corporation's resident agent in Nostate is John Doe, I, whose address is 8888 Nostreet Lane, Nowhere city, NS 88888
ARTICLE SIX: AUTHORITY TO ISSUE STOCK
The Close Corporation shall have authority to issue Common Stock in accordance with the following.
SECTION 1: SHARES OF COMMON STOCK
One Hundred Ten Thousand (110,000) shares shall be Common Stock, and the par value of each of such shares is One Point Zero Zero Dollar(s) ($1.00), amounting in the aggregate to One Hundred Ten Thousand Point Zero Zero Dollar(s) ($110,000.00). The preferences, limitations and relative rights of the Common Stock shall be as hereinafter set forth:
A. DIVIDENDS OF COMMON STOCK
The holders of Common Stock shall be entitled to share equally all dividends declared and paid by the Close Corporation.
B. VOTING RIGHTS OF COMMON STOCK
The holders of record of Common Stock shall have one vote, on all matters upon which stockholders of the Close Corporation may vote, for each share of Common Stock held by them, except as such rights are modified in the ARTICLE SEVEN.
ARTICLE SEVEN: VOTING RIGHT EXCEPTIONS
(To be added from the user interface).
ARTICLE EIGHT: ELECTION OF THE DIRECTORS OF BOARD
The initial board of directors consists of one director. Before an election takes effect, John Doe, II serves as the initial director of the Close Corporation. Election of directors need not be by written ballot.
ARTICLE NINE: MAILING ADDRESS OF INCORPORATOR
The name and mailing address of each incorporator is as follows:
John Doe, III
7777 Nostreet Lane, Nowhere City, NS 77777

What is claimed is:

1. A system for drafting documents, the system having a server connected to a network and a client computer with a user interface connected to the network so that the client computer is able to access the web pages from the server, the system comprising:
the server running a database application holding plural document components and at least one database table having fields for storing component Id, document values, document title, and position values, and text variable names for each of the document components, the text of each of the document components containing plural text variables;
the client computer running a drafting page on its user interface, the drafting page having an area for displaying the text of each of the document components, an area for displaying the definition for each of the text variables for each of the document components, and plural input boxes for accepting the values for the text variables for each of the document components;
means for finding a document;
means for retrieving at least one set of document components by using document values, document title, or document name, each set of components being for a particular document;
means for sending the values for the text variables for each of the document components to the server for processing;
means for processing the document components so that the text variables are replaced by the values from the input boxes to form a final document; and
means for displaying the final document on the user interface on the client computer.

2. The system of claim 1 wherein the document components in the database constitute plural documents, and wherein the user interface contains a search window for finding a document and causes the document to be loaded on the drafting page.

3. The system of claim 2 wherein the drafting page further contains plural buttons selected from global setup buttons, insertion button, delete button, and update button;
and wherein the system further comprises means for deleting a document component, searching for a new document component, and updating the drafting page.

4. The system of claim 2 wherein the database further contains fields for storing component titles, help texts for each of the document components, and version information.

5. The system of claim 2 wherein means for performing a function selected from the group consisting of labeling the components by a proper numbering scheme, conducting mathematical computation, and creating internal references.

6. The system of claim 1 wherein the drafting page further contains plural buttons selected from global setup buttons, insertion button, delete button, and update button; and wherein the system further comprises means for deleting a document component, searching for a new document component, and updating the drafting page.

7. The system of claim 6 wherein the database further contains fields for storing component titles, help texts for each of the document components, and version information.

8. The system of claim 6 wherein means for performing a function selected from the group consisting of labeling the components by a proper numbering scheme, conducting mathematical computation, and creating internal references.

9. The system of claim 1 wherein the database further contains fields for storing component titles, help texts for each of the document components, and version information.

10. The system of claim 9 wherein means for performing a function selected from the group consisting of labeling the components by a proper numbering scheme, conducting mathematical computation, and creating internal references.

11. The system of claim 1 wherein means for performing a function selected from the group consisting of labeling the components by a proper numbering scheme, conducting mathematical computation, and creating internal references.

12. A method for drafting documents using a computer-based drafting system having a drafting page on a user interface, the system running a database having fields for storing record id, document values, position values, component titles, and component texts, the method comprising the steps of:
retrieving plural document components for a document;
extracting the text variables from each of the document components;
displaying the text and title for each of the document components on a display area of the drafting page;
displaying text variable names or their meanings on an input area of the drafting page;
associating the text variables with the values entered from the user interface;
transmitting the values entered from the user interface to the processing unit of the system;
processing the document components to form a final document by replacing the text variables with respective values entered from the user interface; and
presenting the final document on the user interface.

13. The method of claim 12 further comprising:
creating cross-reference within the final document or between two final documents; and
conducting mathematical computation and printing the result on the text of the final document.

14. The method of claim 13 further comprising:
generating a search form clicking on an insertion button on the drafting page; and
conducting a search and returning a search result upon submission of the search form.

15. The method of claim 12 further comprising:
generating a search form clicking on an insertion button on the drafting page; and
conducting a search and returning a search result upon submission of the search form.

16. A computer program product for use by a user in drafting documents, the computer program product comprising a computer usable medium having computer readable code embodied on the medium, the computer program code further comprising:
program code for accessing a database to retrieve the texts of document components, position values, and text variables using document values, document title, or document name;
program code for retrieving plural document components by using a retrieval criteria, the document components being for at least one document;
program code for generating a drafting page on a computer user interface, the drafting page having an area for displaying the text for each of the document components, the names or definitions of the text variables for each of the document components, and input boxes for the variables for each of the document components;
program code for replacing the text variables with the values entered from the user interface to produce a final document; and
program code for displaying the final document on the computer user interface.

17. The computer program product of claim 16 further comprising program code for conducting mathematical computation.

18. The computer program product of claim 17 further comprising:
program code for making cross-reference in the final document; and
program code for updating the drafting page reflecting a deletion of a document component or insertion of a document component.

19. The computer program product of claim 16 further comprising:
program code for making cross-reference in the final document; and
program code for updating the drafting page reflecting a deletion of a document component or insertion of a document component.

20. The computer program product of claim 16 further comprising:
program code for generating a search form on the user interface; and
program code for conducting a search upon submission of the search form by a user.
